(19) United States
(12) Patent Application Publication
(10) Pub. No.: US 2008/0046387 A1
(43) Pub. Date: Feb. 21, 2008

(54) SYSTEM AND METHOD FOR POLICY BASED CONTROL OF LOCAL ELECTRICAL ENERGY GENERATION AND USE

(76) Inventors: RAJEEV GOPAL, NORTH POTOMAC, MD (US); ROHIT GOPAL, NORTH POTOMAC, MD (US)

Correspondence Address: RAJEEV GOPAL, 15807 SEURAT DRIVE, NORTH POTOMAC, MD, 20878, US

(21) Appl. No.: 11/459,353

(22) Filed: Jul. 23, 2006

(51) Int. Cl. G06F 17/00

(52) U.S. Cl. 705/412

(57) ABSTRACT

A system with automatic control of local generation, consumption, storage, buying, and selling of electrical energy is provided. This automation can be governed by optimization criteria and policies established by the administrative entity responsible for the domain benefiting from this invention. The control method, using a data processing computer, implements the optimization criteria and provides near real time directives for the system. The control program estimates energy generation and consumption, monitors voltage and power levels, configures the power circuit and adjusts device specific controls over a network. Depending on a specific situation, the control program can continue to store extra energy, sell energy for a financial gain, maximize sustainable generation to meet social obligations, or increase consumption for extra comfort. This control program optimizes on multiple time granularities under a variable pricing scheme and environmental conditions, with related information including weather forecasts accessed over the Internet.

### BACKGROUND OF THE INVENTION

1. Field of the Invention

The present invention is in the field of control system for local electrical energy generation using solar cells, adjustable energy consumption, energy storage using battery, and selling electrical energy to the grid with the various devices connected over a configurable power circuit within a domain and under the control of software running on a data processing computer. More particularly, the control system utilizes a policy driven hierarchical optimization scheme and employs a local area network for sending configuration commands to the power circuit and devices and for collecting monitoring data. Even more particularly, a control processor running software programs implements the optimization methods and further enhances its optimal decision making capabilities by leveraging information sources for weather forecasts and energy pricing data over the Internet.

2. Discussion of the Background

Modern society critically depends on a wide availability of cost-effective energy sources to meet its commercial, manufacturing, business, agricultural, transportation, and residential needs. Because of a growing population, increasing energy demands, and diminishing crude oil reserves, the price of usable energy is rising resulting in a need for innovative solutions for its effective management. It is recognized that electrical energy (commonly referred to as power which measures its rate or energy per unit time) plays a crucial role in the society because of its attractive generation, distribution, and usage characteristics. Most of the electrical energy is generated in large centralized power plants by burning fossil fuel (coal, gas, and miscellaneous petroleum based products), and by using hydroelectric reservoirs or nuclear fission process. Electrical energy is transported to customers over utility power grids for consumption which is metered for billing purposes. Even though the traditional methods dominate overall electrical power generation, new technologies that harness sustainable geothermal, solar, wind, and tidal energy sources are now also maturing fast.

It is recognized that besides the costs of fuels, generation plant infrastructure and power distribution grids, the society may also be paying a high long-term price because of a rampant use of fossil fuels as the combustion process may be causing an unprecedented rise in carbon dioxide and other harmful gases in the atmosphere. Besides adverse health implications because of the pollution associated with fossil fuel burning, most environmental scientists now believe that an excessive rise of atmospheric gases such as carbon dioxide could be causing global warming due to a greenhouse effect and thus resulting in unexpected and increased melting of glaciers and the polar ice caps, and other permanent changes in global climate. It is further recognized that a potentially harmful environmental impact of fossil fuel burning and an increasing price of crude oil have reinvigorated scientific and technical efforts to improve the electrical energy generation technologies, reduce energy consumption, introduce automated energy management, and expand the use of sustainable energy sources.

Governmental agencies have realized the importance of sustainable electrical energy generation. They have started offering financial incentives such as tax rebates to help defer the high initial capital cost of the generation units that can be used by a domain such as a residence. Because of a time-based and seasonal variability in the consumption and generation patterns (such as with solar photo-voltaic panels), it is difficult to estimate the fixed capacity of such generation units for a domain. Accordingly, the governmental agencies are stipulating that power generation utility companies should be willing to buy back any surplus energy that is locally generated in the individual domains. This buy-back provides an extra financial support to the domain and encourages the overall use of sustainable energy sources. It is common knowledge that electrical energy can be stored, for example by using a battery, for later use. It makes economic sense for a domain to maximize the benefits of such energy sale by storing energy when the price is low so that it can be sold when the demand (and the associated price) is higher. The combination of the various needs listed above results in need for an invention of a computer-based energy management system that can automatically make optimal decisions for generating, storing, using, and selling electrical energy for a domain.

Those well versed in the art and practice of electrical engineering are aware of the various technical challenges, installation and maintenance costs, and operational losses associated with the transportation of electrical energy over power lines because of the resistive, capacitive, and inductive effects. However, the traditional generation technologies required economies of scale resulting in the installation of high capacity centralized power generation facilities distributing electrical energy over public utility grid to a large number of individual domains. Because of fuel-burning, nuclear reaction or adjacency to a water reservoir, these power plants are typically located far away from the population centers. Some of the recent energy generation technologies are environment friendly and can harness sustainable energy sources, such as solar and wind, efficiently even at a smaller scale and thus enable the use of smaller generation devices that can be deployed locally within a domain. Examples of such an energy domain can be a residential dwelling unit, an academic campus, or a factory, which typically use a variety of electrical energy devices and have the capability to install and operate local generation and storage units under the policies of an administrative entity. Such policies are used by the energy control system to make near real time decisions for optimally managing energy generation and usage within the domain. Such decisions can include buying and selling of electrical energy to the power grid as well. An innovative computer-based system that automates the various facets of energy generation and consumption under the control of an optimization method is required to fully leverage many possibilities in such a distributed energy generation scenario using sustainable sources. Unlike the large power plants which have dedicated operational staff, the smaller domains would need a policy-based automation to make the local power generation operationally efficient and economically feasible.

A distributed generation of electrical energy is fast becoming a financially viable practice with the reducing price of solar and wind power generation devices. Because of an inherent variability of such sustainable power sources, earlier inventions have identified the use of storage devices to smooth demand with respect to generation. For example, U.S. Pat. No. 6,858,953 to Stahlkopf teaches how to use an interface between wind power farm and grid transmission lines to make such power generation more stable and smooth by acting as a shock absorber. It is also a common practice for the utility companies to price their power depending on the existing demand resulting in a time-of-the-day and seasonal variations. Many jurisdictions have mandated that the utilities should allow the consumers to sell back any extra power that has been locally generated. U.S. Pat. No 6,570,269 to McMillan teaches method and apparatus for supplying power to a load circuit from alternate electric power sources using an inverter facilitating such sell back to the power utility.

There is a clear need for optimally managing the generation, consumption, and storage of energy within a domain. A simplistic design of such an energy system will tend to overestimate the size of generation and storage devices resulting in higher initial installation costs and thus would limit the deployment of such solutions. By incorporating decision making knowledge in control software, timely decisions can be made more frequently and efficiently and thus can provide better overall benefits for a smaller initial infrastructural investment. The current practice in the installation of such local power generation systems is to use a fixed power circuit which allows surplus generated power to be stored in the battery or to be sold immediately to the power utility at the current price, without benefiting from selling at a higher price later. Time based configuration for some simplistic systems may be possible but it has to be explicitly specified for every day, week, and month. This requires manual configuration changes on a daily basis or very detailed configuration data which has to be manually entered that may need to be revised based on the varying external environment. A computer based integrated control system that directs a configurable power circuit for optimal energy flow within and without the domain can achieve many advantages not possible in its absence. Certain decisions in such a system require a configurable power circuit so that by establishing specific connectivity it is possible to allow the flow of electrical energy between certain locations in the circuit and not others. A simplistic, fixed power circuit topology typically offered through inverters, for example, cannot preclude simultaneous charging of battery and selling of extra power even though optimal decision may be not to charge the battery and sell all the excess energy to the power grid. A configurable power grid can, in this situation, can take the battery out of the path between the solar panel and the external power grid and thus sell all the generated energy immediately for maximal financial gains.

Simple inverter designs, typically implemented through electronic circuits or Digital Signal Processing (DSP) programming, primarily convert Direct Current (DC) into Alternating Current (AC) and in addition perform tasks such as battery charging or driving an electrical load. U.S. Pat. No. 5,327,071 to Frederick et al. teaches us the use of such a converter (inverter) in a solar power system. However, such simplistic decisions normally built into inverters are limited to real time signal processing for AC to DC conversion and are myopic and short-term oriented with respect to energy flow control which can lead to a suboptimal decision in a long term. Furthermore, these simple local energy generation systems assume the use of a specific energy device with intelligence such as an inverter, and thus are limited with respect to full configurability and connectivity in the power circuit. Among many scenarios which are not addressed well by these simplistic schemes, one such scenario could be as follows: generate solar energy, reduce consumption, store the surplus during the morning hours and sell the surplus energy to the utility grid when the price is highest on the hottest week day of summer months. It is obvious that a capable energy control system will need to process environmental conditions around the domain and time-based and seasonal variation patterns in a generic policy-based fashion. It will need to be able to decide that immediate selling of surplus energy may be sub-optimal, and furthermore need to be able to determine the right time to sell energy based on pre-determined prices and ever changing weather affecting both energy generation and usage. With the availability of Internet web sites providing weather data, such control systems can additionally pre-determine that because of an expected overcast sky in the late afternoon, the selling decision should be modulated and stored energy be preserved to meet the expected higher consumption demand in the evening. By interfacing with other information sources that contain the energy usage plans of the users, the control system can further ensure that the future domain energy demands are fully considered in its near real time energy control decisions. Without such an automated control, these decisions will be cumbersome, inefficient, error prone, and expensive to preclude their wide deployment. With automation, such decisions and their overall success in meeting the optimization criteria can make the energy generation infrastructure can become financially viable for a large number of domains. This automation using a data processing computer can also be used to keep a record of energy produced via sustainable means such as wind and power. This information can be used to measure the effectiveness of green energy initiatives in a jurisdiction comprising the domains equipped with such energy control systems with local power generation.

Many energy consumption devices can be controlled, often through a manual switch, to regulate energy consumption rate. It will be beneficial if such devices can be equipped with computer controlled electronic switches to enable remote control from a centralized processor providing near real time directives based on a specific policy and strategy. Additionally, many energy consumption devices allow the level of energy consumed. For example, an air conditioning thermostat can be set at a low or high setting to balance energy consumption and the comfort desired by the users. Bringing generation, consumption, and conservation within a single framework and under the control of a single data processing computer adds much value towards global energy optimization within the domain. It is a common practice to use similar computer-based control processors to manage other fluid commodities such as wireless communication network ingress and egress capacities with respect to a specific networking node by adjusting bandwidth allocation based on historical, current, and predicted demands with respect to that node and the availability of shared network resources and by adapting the network topology compatible with these bandwidth allocation decisions. An innovative application of similar network control and monitoring techniques makes it also possible to control electrical energy use and generation in a domain. Besides controlling energy consumption and storage, such automation can also improve conservation, for example, by changing the reflectivity and heat transmission characteristics of window panes or curtains based on policy and optimization criteria. Recent advances in lighting bulbs with plurality of light emitting diode elements now make it possible for very high power efficiency (compared to incandescent bulbs) while preserving almost continuous variability (unlike fixed intensity compact and power efficient fluorescent bulbs).

With an automated control, it now becomes possible to make and execute the various decisions for the level of energy generation, consumption, storage, selling, buying, and conservation based on an overall optimization strategy. This innovative control strategy makes optimal decisions that are not likely to be made in a piecemeal control of energy storage or sell-back over fixed power circuits. Under this comprehensive framework, the unified sum, under an informed optimizing control processor with a global view of the optimization domain and access to historical data such as past demands and external information such as weather forecasts, is more effective than the aggregation of individual incremental decisions executed in a piecemeal fashion. It is well known that energy consumption is highest for the devices that generate heat. This includes heat pumps augmented with electrical heating elements, ovens, stoves, and water heaters within a residence. Devices such as ovens and stoves are manually controlled and have minimal latitude with respect to decreasing or increasing the objective temperature since the temperature is determined by the recipe for cooking food for a fixed time duration. However, it is possible to better schedule such heavy energy usage, consistent with the optimization strategy (e.g., pricing based on time of day, maximal energy generation at certain time, other anticipated loads at that time). These schedules can be recommended by the control processor using a variety of mechanisms and information already generated for decision making. These recommendations can include a detailed listings of suggested times for the day and week when a high energy use device should preferably be used without forcing any deviation from the required objective temperature that will compromise a correct application of the device.

An energy optimization framework requires monitoring of various devices within the domain and the use of historical and external information that is processed by software programs coding the knowledge to make decisions influencing device behavior. Such monitoring can also be used to determine the working status of a device, identify any failure and subnormal performance for any repair and adjustments. For example, a significantly above-average energy consumption by an air-conditioning device compared to its historical performance, after making due seasonal corrections, can point to impending problems in the compressor. This potential problem can be handled with an immediate and cheaper repair as opposed to an eventual replacement without any preventive repair. With automation, detailed measurements collected by the control processor and the other decisions made by it provide a rich set of historical data that can be used, after suitable aggregation and summarization, to determine the usefulness of sustainable energy sources, system designs, specific policies, and conservation techniques. With the increasing price of fossil fuels, global warming, and a burning desire to take concrete steps, such information will be quite valuable to introduce further innovations, attract new users and make informed capital investments in managed local energy generation. These and many other advantages including these listed here can be provided by one or more embodiments of this invention which is described below.

### BRIEF SUMMARY OF THE INVENTION

According to one aspect of the present invention an automated policy driven control system is provided that can make informed decisions affecting the behavior of energy generation and use within a domain. A configurable power circuit with remote controlled switches is used to interconnect various energy generation, storage and consumption devices. A local area network is used to connect the various switches of the power circuit, remote controlled energy devices, and measurement devices to a control processor that provides near real time decisions. To make the invention practical and usable such decisions based on optimization criteria, historical information, current status of the various devices, estimates for future needs, and environmental conditions are made in an efficient and cost effective fashion. This requires an automated approach that can preserve the system state variable values estimated during a long term planning phase and their subsequent near future revisions based on the actual measurement data collected from the devices and external information sources. These estimated state variables provide a bounded region within which a near real time decision process can actually set the optimal energy storage, selling, and purchase values. This innovative hierarchical partitioning of the control method into three phases (long term planning, short term updates, and near real time decision making) makes it feasible to use a general purpose data processing computer for this invention. Thus the system allows the implementation of the control method as software programs running in a control processor for maximum processing and storage flexibility and under the policies specified by the administrative entity responsible for the domain.

One embodiment of this invention uses solar photo-voltaic panels that are connected to a power circuit within the domain. Based on the location of the domain and jurisdictional stipulations, additional wind turbines can also be added to the power circuit. One or more such generation devices can be connected together to provide the desired voltage and current levels compatible with the needs of the users and various system design criteria. The power circuit itself comprises multiple electronic or electro-mechanical switches at suitable locations thus making the circuit configurable under the control of the optimization method. A specific topology of the circuit, with a set of switches which are on or off, determines the flow of electrical energy possible over the circuit. One or more batteries, for storage, are also connected to the circuit through inverters for converting DC into AC.

The consumption devices within the domain provide the electrical load to the circuit. The devices, which do no have their own dedicated control mechanism, are connected to the power circuit through specific switches to control power consumption. The measurement devices include voltmeter, ampere-meter, and watt-meter which are located at specific points of the circuit so that at least the overall energy generation, consumption, storage, buying, and selling can be measured by the control processor. The electrical measurement data is sent to the control processor over a Local Area Network (LAN). The control data items, corresponding to the near real time decision making by the control processor, are also sent from the control processor to the configurable circuit switches over the LAN for setting a specific circuit topology and also to control specific consumption devices which are equipped with local control apparatus such as a thermostat.

In yet another aspect of this invention, a method is provided for making optimal decisions about energy generation, use, storage, selling, and buying based on specific optimization criteria. One such criterion could to be to enhance the economic value enabled by this invention in reducing the overall cost of energy use within the modular domain. Another criterion could be to provide accurate information related to the type of source used for such energy use such as solar and wind with its environmental implications in maximizing the use of sustainable sources for energy generation. Yet another criterion is related to the level of comfort desired during the use of one or more energy consuming devices such as leisure or work-related lighting, temperature and air-flow control within the domain. These optimization objectives are implemented by the control method which also has access to the generic decision making knowledge, past information about energy decisions made by the method, the current status of various energy devices, weather forecasts, and estimates for energy use and generation for near and long term future in implementing optimal decisions.

In yet another aspect of this invention, a control processor with a general purpose Central Processing Unit (CPU) running a multi-tasking operating system is provided for making optimal decisions. Multiple software programs run over the operating system implementing specific aspects of the optimization method including monitoring, measurement, estimation, control, interface to users, and interface to external web sites. This CPU is interfaced with a persistent storage device, such as disk drive, where the programs, policies, their intermediate calculations, decisions, and historical monitoring information are stored. A network interface, using WiFi or wired Ethernet, links the control processor with other energy devices for monitoring and control. The same networking interface is also be used to provide network data links to other data sources within the LAN environment of the domain or over the Internet. Standard network layer protocols Hypertext Transmission Protocol (HTTP) and Transmission Control Protocol/Internet Protocol (TCP/IP) are used for exchanging information over these networks. In some cases protocol adapters such as serial to IP packet conversion are utilized for interfacing with a device with support for a serial interface such as RS-232. The administrative entity responsible for the domain uses a computer console running a web browser for providing policies and other data to guide the decision making capability of the control processor. This web browser computer is interfaced with the control processor using HTTP protocol, either over the LAN or remotely over the Internet. Besides the web browser for user interface, control processor also uses email notifications for sending information to the administrative entity and other users in the domain.

### BRIEF DESCRIPTION OF THE DRAWING

The present invention provides significant advantages which can be better appreciated once a detailed understanding by a reference to the following descriptions is considered in conjunction with the accompanying drawings, wherein:

FIG. 1 is a block diagram illustrating one embodiment of an energy control system showing the control processor and various electrical devices within domain;

FIG. 2 is a electrical power topology diagram showing the interconnectivity of the various devices over the power circuit in one embodiment of the system of FIG. 1;

FIG. 3 is a network topology diagram showing the monitoring and control of various devices over the local area network in one embodiment of the system of FIG. 1;

FIG. 4 is a block diagram illustrating an embodiment of the control processor;

FIG. 5 is a graph showing use, generate, buy, sell, and store variables for multiple time intervals and surplus and deficit regions;

FIG. 6 is a block diagram showing multiple layers of hierarchical energy control method;

FIG. 7 is a dependence diagram showing interdependence relationships among the various system variables;

FIG. 8 is a flow chart showing a long term planning method to determine estimates for the various variables;

FIG. 9 is a flow chart showing a near term decision making method;

FIG. 10 is a flow chart showing a method for updating short estimates based on actual values; and

FIG. 11 is a block diagram showing the various software programs and their interfaces with each other and some external entities.

### DETAILED DESCRIPTION OF THE INVENTION

The following describes one embodiment of an automated electrical energy control system for making optimal decisions via the monitoring and control of the various devices within a domain. A domain can be a residential or commercial facility equipped with solar based energy generation, with battery for storage, and optionally connected to the utility grid and optionally connected to the Internet. In this description specific details are documented to facilitate a thorough understanding of the invention. It should be clear that not all of these details are required for a specific embodiment of this invention, but are rather present to provide an example by which a thorough explanation of the mechanizations of the design can be made. In some cases, some well known artifacts, structures, and techniques are described and depicted in diagrams at a block level to ensure that the main facets of the inventions are not obscured.

The present invention provides an electrical energy control system that makes automatic decisions to optimally generate, use, store, buy, and sell energy within a domain driven by the policies from the administrative entity. A control processor is used within the domain to implement this decision making process based on a variety of information from within and outside the domain. A configurable power circuit topology is used to inter-connect the various energy devices. A local area network is used so that the control processor can get measurements from the various devices in the domain and also so that the control processor can send configuration data to the various devices including the switches in the configurable power circuit. There is also an optional interface to the Internet so that the control processor can obtain information related to weather, geopolitical events, and pricing from public utilities. Alternatively, default values are provided to the system during software installation and updated through local user interface used by the administrative entity of the domain. Within the domain, the decision making is designed as a hierarchical long-term and near-term optimization problem with varying constraints and a multivariate control system environment.

The overall objective for the control system is to minimize or maximize a specific goal that functionally depends on multiple independent variables, some under the direct control of the control processor, while complying with multiple environmental constraints. Under a specific selected optimization scheme, there is a long term planning phase where estimates for the various generation, consumption, and storage decisions are made and stored in a local persistent memory device for multiple time intervals comprising a time span of one year. This long term planning is done in advance for all intervals so that for a specific current time interval a more precise algorithm can make immediate decisions on the fly using the current actual conditions, measurements and the stored estimates which were calculated earlier. This current actual information is also used to revise the estimates for the immediate intervals in the short term future following the current time interval. There are many different possibilities for the optimization goals. In one embodiment, the overall goal of the energy control method is to maximize the aggregated financial value for all time intervals where financial value at an instance is the difference between the sale of energy and the purchase of energy as a function of time of the day, weather condition, price of purchased energy, and selling price of energy sold to the grid.

The control variables which can be changed by the control processor for a specific time interval are energy storage, energy consumption, energy purchase (buying) and energy sale (selling). The generation of solar energy is driven by weather conditions and time of the day and it acts as an environment variable (beyond the control of the system). The prices of energy buying and selling are examples of the environmental variables that can influence the control process. The measured values of the various voltage, current, and power levels at specific points in the power circuit belong to the set of state variables monitored by the optimization method. The various constraints for the optimization method include the user preferences for comfort (usage of energy consumption), the maximum battery capacity for energy storage, the maximum solar photo-voltaic capacity for energy generation, and the domain circuit and grid capacities limiting the maximum amount of energy that can be transmitted for energy sale or purchase during a time interval.

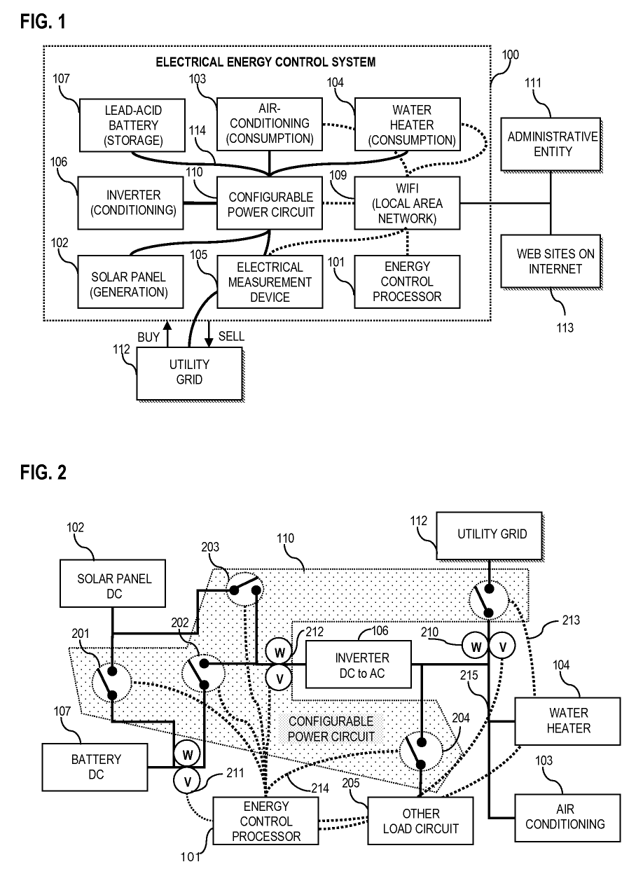

FIG. 1 shows a block diagram of an embodiment of the electrical energy control system 100 where an energy control processor 101 monitors and controls energy devices inter-connected via a configurable power circuit 1 10 (for electrical power distribution) within a residence (domain). As shown, an energy control processor 101 logically interfaces with at least one solar photo-voltaic panel (energy generating device) 102, lead-acid battery (energy storage device) 107, water heater 104 and air-conditioning 103 (examples of energy consumption device), DC to AC inverter 106 (energy conditioning device). The control processor 101 uses a WiFi LAN (local area network) 109 to monitor these devices, collects data from electrical measurement devices 105 and provides configuration directives to the power circuit 110 and some consumption devices 104 and 103 based on near real time decisions facilitated by pre-determined long-term estimates. The control processor 101 makes multiple decisions for the current time interval and one such decision could be to sell excess energy within a domain to the local utility (external power) grid 112. The administrative entity 111 accesses the energy control system 100 using a web browser located either within the LAN 109 or connected to the system remotely over the Internet. External websites 113 for pricing and other information related to energy management are also accessed over the Internet. The configurable power circuit 110 connects to the battery 107 via a power line 114.

Many variations on this embodiment are possible by swapping specific instances listed above for the considered configuration. For example, instead of solar photo-voltaic panels 102, one can use wind turbines for local energy generation. Similarly, instead of using lead-acid battery 107 different types of battery, such as lithium ion or nickel magnesium hydride battery can be utilized to meet specific cost, capacity, and longevity requirements. Yet another instance of this invention can use a hydro-reservoir for storing excess electrical energy as the potential energy of water which has been pumped to a higher level. Electrical energy can then be generated from the raised water as it flows down to a lower level and drives a hydroelectric turbine. Another instance of energy storage can involve kinetic energy stored in sealed flywheels as increased angular momentum which can then drive a generator when kinetic energy needs to be converted back to electrical energy for the domain use. Each specific generation and storage device has unique electrical energy conversion and storage efficiency which is duly reflected in associated device model coded in software programs implementing the control method. Similarly, examples of consumption devices 103 and 104 can be replaced by other energy consuming devices, such as lighting and appliances, to fit the purposes of the consumption devices in practice.

The domain itself could be a residence where the owner serves as the administrative entity 111 as described here in more detail. Alternatively, a commercial building used for offices, factories, etc. can also benefit from this invention with the building manager serving as the administrative entity. An educational institute with a campus comprising multiple buildings can also leverage a scaled version of this invention in either a centralized mode where a single larger control processor is utilized for multiple buildings or as an aggregation of distributed energy control sub-domains, each with its own dedicated energy control processor 101. In the second case, the individual energy control processors are still driven by the policies provided by the administrative entity 111 who could be the site facilities manager. These are only some examples of different combinations and many more such combinations can easily be identified which are all subservient to the innovative aspects of the invention in managing energy generation, storage and use within a domain.

In the energy control system 100, solar (photo-voltaic) panels 107 in FIG. 1 convert solar photonic energy into electrical energy. The photons present in the sun light incident on the solar panels excite electrons in the semiconductor, either amorphous or crystalline, that is deposited as a layer on a solar panel. These electrons eventually create an electric potential (voltage) and drive electrical current in the external circuit connected to the panel. By using a combination of solar panels in series (to increase voltage) and parallel (to increase current), the desired energy generation rate or power (wattage) is achieved. The solar panels are connected to the configurable power circuit 110, illustrated with more details in FIG. 2, which is dynamically configured by the control processor 101. The distribution circuit, for example in a normal daylight operation, will connect the load for air-conditioning and some lights to solar panel via inverter 106 for Direct Current (DC) to Alternating Current (AC) conversion. At the same time if the generated power is sufficiently high, the configurable circuit will also connect the batteries to the solar panels as directed by the control processor. Since the voltage output of the solar panel 102 is higher than the battery 107, an electrical current will flow from the solar panel to the battery and will start charging the battery. At the same time, the inverter will convert the 48 VDC (as an example) from the solar photovoltaic panel into 120 VAC (typical residential voltage) which is connected to the load part of the configurable power circuit 110 to drive air-conditioning 103 and water heater 104. Since sufficient energy is generated and it is also at a higher voltage compared to the load or the utility grid 112, the electrical energy will not flow from the utility grid to the domain load and the utility meter will stop charging for the energy consumed in the residence while solar panels 102 are generating enough local electrical energy to meet the domain demands for consumption and storage.

The typical electrical energy demands of a residential domain depend on several factors including the size of the house, building material used, insulation material used, geographic location, weather pattern, energy consumption preferences, various energy consumption devices, and utility pricing. A typical calculation for the solar panel based energy generation is shown below which helps in sizing the capacity of the solar photo-voltaic panels 102, inverter 106 and battery 107 in the system to meet the average domain demands on a long term. Since solar panels work effectively for only a few hours a day, a higher solar generation and battery storage capacity, compared to the peak and average energy consumption estimates for the domain, is needed.

| Consumption | | | |
|---|---|---|---|
| Device | Power (watts) | ×Time (hours/day) | =Daily Energy |
| Refrigerator | 200 | 12 (50% duty cycle) | 2400 |
| Lighting | 200 | 4 (evening only) | 800 |
| Heater | 1000 | 1 | 1000 |
| Television | 200 | 4 | 800 |
| Air-Conditioning | 1000 | 6 (25% duty cycle) | 6000 |
| Total | 2600 | | 11000 |
| | (2.6 kw) | | (11 kwh/day) |

Based on this analysis, a 2.6 Kilo Watt (kw) peak power load will require a 4 kw inverter to meet the peak demands and support some future addition of load within the domain. The solar photo-voltaic panels must be able to produce 11 Kilo Watt Hour (kwh) energy per day. The area of photo-voltaic panels is based on average sunlight conditions for the location of the domain and the conversion efficiency of the panel. For example, a 1 kw solar panel can produce approximately 2.5 kwh within a day (with multiple hours of sunlight most of the days), so for this domain an array size of approximately 11/2.5=4.4 kw would be required, which would take some 350 square feet of surface area. For at least one day of energy storage, 12 kwh of battery would be required, which can be supplied by approximately 16 typical flooded lead-acid golf cart batteries. It is recognized that the solar panels 102, inverter 106, and the batteries 107 are the highest cost items for a typical energy control system installation for a domain and have to be carefully sized for controlling initial infrastructural costs of the energy system.

The solar photo-voltaic panels are arranged in a configuration to generate 48 VDC and 11000 watts of electrical power during peak operating conditions. The output of the solar panels 102 is connected to a configurable power circuit 110 and also to the lead acid battery 107 as shown in FIG. 2. There is a volt meter and wattmeter 211 attached to the battery 107 prior to the power circuit 110 so that energy storage and retrieval can be measured for a specific time interval. The voltmeter and wattmeter take measurements and convert the electrical values into digital data that is transmitted to the control processor over a serial line or WiFi LAN 109. Proximity of the measurements devices to the distribution panel (configurable power circuit) 110 facilitates the use of serial wires (as an option) between the devices and the control processor 101 which can also be located near the configurable power circuit 110. The measured values are transmitted to the control processor 101 at a preferred interval of 10 seconds. Up to 6 measurements can be made while the near real time decision making is progressing for the current single time interval of length 60 seconds (as described later). Depending on the sun light conditions, the voltage output from the solar panel 102 will range from 0 to 48 VDC and power will range from 0 to 12000 Watts. Electrical current in the circuit 110 is not explicitly measured since it can be determined as a dependent variable from the equation current=power/voltage. On receiving the measured data, the control processor 101 adds a time stamp to the measured values and stores them in the permanent storage as actual values associated with the solar panel 102 for the specific time interval. These values are also used in the decision making method as described later.

As shown in FIG. 2, a DC to AC inverter 106 is used in an embodiment of this invention. The inverter 106 is rated at 4000 Watts to adequately deal with peak energy generation capability of the solar photo-voltaic panels 102 for the energy control system 100. The 48 VDC output from the solar panel 102 can be selectively connected to the battery and or inverter through the configurable power circuit 200. Electrical energy from the solar panel charges the battery since the voltage at solar panel 1 02 is higher compared to a (not fully charged) battery 107. Any extra current, not used for battery charging, will flow to the inverter 106 provided the configurable power circuit 200 is appropriately configured by the control processor 101. An inverter 106, similar to solar photo-voltaic panels 102 and batteries 107, is a commonly available electrical device and the present invention does not depend on the actual technology or components used to implement the inverter itself 106. Only the input and output specifications compatible with the present invention are of importance. The output of the inverter 106 is at 120 VAC and is connected, through a controlled switch 204 in the configurable power circuit 110, to the other parts of the power circuit. The phase and frequency of the output AC is in sync with the AC power from the utility grid 112 which is accomplished by having the inverter 106 sense the external sources of AC from utility grid 112 and lock in the phase and frequency for the AC electricity converted from the solar panel or the battery. A voltmeter and watt-meter 210 are attached at the input of the utility grid 112 to measure the AC voltage and power with respect to the grid. The voltmeter and watt-meter 210 make the measurements at a fixed interval of every 6 seconds and provide measured values to the control processor over serial lines or the WiFi LAN 109. This arrangement provides up to 6 samples of this measurement for a specific time interval when the near real-time decision making is progressing in the control system.

The configurable power distribution circuit 110 shown in FIG. 2 is implemented by a plurality of electronic (solid state) switches based on power transistors for fast response and by using control signaling from the processor 101 (at lower voltage compared to power circuit) so that the power transistor can implement connections for specific parts of the power circuit carrying 120 VAC. An electronic switch 201 connects, directed by control processor 101, the solar photovoltaic panel 102 with the battery 107. Similarly, the switch 203 provides controlled connectivity between the solar panel 102 and inverter 106, and the switch 202 provides a similar controlled electrical connectivity between the battery 107 and the inverter 106. The configurable power circuit 110 is an improvement upon the traditional electrical distribution panels generally used to distribute utility power within a residence and accordingly includes all its functions. Ordinary distribution panels typically include an input point for one or more phases of AC current from the power source. The load for the entire residence is distributed over multiple load circuits rated by the current handling capability (typically 10 to 30 Amperes) of each circuit. A dedicated circuit is used for high energy consumption devices such as electric stoves, electrical garbage disposal systems, and air-conditioning 103 devices connected with a power line 215. Lights and common wall-mounted electrical power outlets for an area of the residence are typically on a single dedicated (other load) circuit 205. Such areas could be living room, kitchen, bedroom, etc. in a residential building. Each circuit is protected by its own overload protection circuit breaker integrated within the configurable power circuit 110 which trips when the actual current flowing in the circuit is higher than the rated maximum current limit for that circuit. This circuit breaker is typically reset manually to restore the normal functioning of the affected circuit. The energy control processor 101 controls the switch 204 by sending commands over the wireless LAN link 214 and thus decides how power is consumed by a typical load power circuit 205.

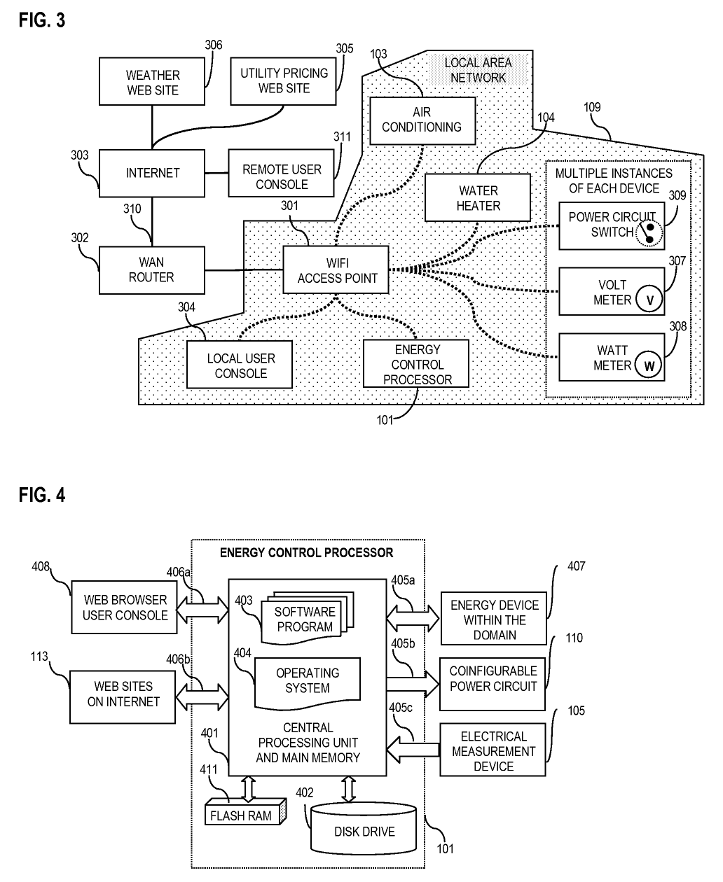

A configurable power circuit 110 in FIG. 3 augments the distribution panel with electronic switching components, driven under the control of the control processor 101 commands transmitted over the LAN 109. A simple on-off switch 204 is implemented using power transistors which essentially connects or disconnects the corresponding power circuit 110 from another point in the configurable power circuit 110 that can source electrical energy. This is one way of controlling energy consumption where a multitude of energy consumption devices (such as lights and small appliances) on that circuit can be disconnected to reduce the amount of power consumption. This bulk arrangement is used for general types of circuits for lightings and power points in the residence. A more effective control of consumption devices is associated with larger loads typically equipped with their own dedicated control apparatus. This includes water heaters 104 where energy consumption is governed by desired temperature level of the water. Besides energy needed to heat up the water, there are also thermal losses because of imperfect insulation for the heater and plumbing. Heat energy is lost at a rate that is directly proportional to the square of the temperature differential between the heated artifact and its surroundings. Thus, a lower thermostat temperature can be used for most of the day, to minimize loss, and the temperature could be increased in the morning when most people are likely to use hot water for shower. The traditional water heaters do allow a change in temperature by mechanically adjusting a dial physically attached to the heater. Heaters are generally located in not an easy to reach location such as basement. For remote and automated management of water heater, a WiFi equipped thermostat is used in the present invention for water heater 104. The water temperature is set by the control processor using decisions based on variety of factors including user preference and optimization objective, time-of-the-day, and season all specified as policy for the system. The control processor 101 sends digital data over the WiFi LAN 109 to the water heater some time before (typically 10 minutes based on the heater capacity and design) the peak use of hot water is anticipated. After the peak consumption period has expired, the control processor changes the temperature back to a lower setting to save energy. This use of the electronically controlled thermostat achieves energy conservation with the present invention without requiring cumbersome, inefficient and impractical visits to the physical location of the heater several tomes a days which besides being inconvenient is also prone to incorrect adjustments.

An electrical air-conditioning device 103 in FIG. 3 can be employed for both heating and cooling the residential domain even though the common usage of the term is generally reserved for cooling a building. To be more specific, a heat pump is used as a general purpose heat transfer device that can actively transfer heat away from the residence to the outside (for cooling) and in the reverse direction from outside to the inside the residence (for heating). Based on the second law of thermodynamics, such a heat transfer against the temperature gradient is possible with an explicit use of external energy. In the case of the heat pump, electrical energy drives a compressor and uses a refrigerant fluid in a closed circuit connecting the inside and outside of the residence. This fluid circuit uses an air heat exchange unit outside the domain and a similar air heat exchange unit inside the residence. Within the residence, it also involves an air fan that forces the inside air, circulating in the house through an air-duct system, through the inside heat exchange unit for effective heat transfer and circulation within the residence. A thermostat is used to control the operation of the heat pump. For cooling, a higher objective temperature results in a lower duty cycle for the heat pump and air fan and saves energy while for heating a lower objective temperature achieves energy savings for cooler seasons when the residence has to be heated. It is recognized that some high end thermostats do provide time-based temperature setting. But in this invention only a simple thermostat with remote temperature setting is needed since the necessary and more sophisticated policy based and globally optimal control logic is implemented in the control processor as software programs. This control logic includes time-of-the-day based decision making, augmented with day-of-the-week, day-of-the-month, week-of-the-month, week-of-the-year and day-of-the-year exceptions. Additionally, the automated control method also factors in the reduced cost of the external energy based on the optimization criteria and personal preferences provided as policy for the control processor decision making. The objective temperature is determined by the control processor executing the optimization method and the digital information for the desired temperature, consistent with optimization goal, is provided over the WiFi LAN 109 to the air-conditioning device 103.

FIG. 3 also shows the connectivity of the domain LAN 109 to the external sites reached over the Internet. The WiFi access point 301 is connected to the Internet 303 with a WAN router 302 with at least 56 kilo bits per second (kbps) data-rate required for information gathering on price and weather and sharing decisions and monitored data. The Internet connectivity over WAN link 310 should ideally be continuous, such as that possible with DSL, cable, or satellite modem. Alternatively, a dial up connection will also suffice which can interact with the external web sites less frequently (once a day as opposed to once during every time interval which would be possible with the use of a continuous Internet connection). The external information sources include the utility pricing web sites 305 and external weather forecast sites 306. The user web console could be directly connected to the LAN 109 as the local user console 304 or over the Internet 303 as the remote user console 103. A domain will typically have multiple instances of the voltmeter 307, wattmeter 308, and power circuit switch 309 which all connected to the energy control processor over the LAN 109.

The control processor 101 is implemented on a general purpose central processor unit (CPU) with random access memory 401 and persistent memory implemented with a hard disk drive 402 as shown in FIG. 4. The processor 101 is configured as an embedded computing device without the need of any dedicated user console for its continuous operation. This allows the placement of the control processor 101 near the configurable power circuit 110 in an un-attended mode. An Ethernet network card for supporting the LAN interfaces 405a, 405b, and 405c and WAN interfaces 406a, and 406b is included with WiFi capability. The control processor 101 can send and receive data over the WiFi LAN 109, for example to communicate with energy device within the domain 407, and interact with external web sites on the Internet 113 and web browser user consoles 408 using 406b and 406a interfaces, respectively. Besides this Ethernet network interface, a removable Flash RAM 411 media is also available as an alternative way of transferring bulk data and software. A general purpose operating system 404, with multi-tasking support, runs on the CPU with drivers to use the peripheral devices including the disk drive 402, flash RAM 411, serial lines (RS-232), and the Ethernet network interface card for WAN and LAN interfaces. The operating system 404 allows concurrent running of multiple software programs 403. Each software program 403 can have one or more threads for performing multiple sub-tasks concurrently. On powering, the processor 401 automatically loads the operating system 404 and starts executing one or more software programs 403 comprising the energy control software suite. The disk drive 402 is used for storing all programs 403, operating system 404, default system variable values, policies, measured data, estimates for state variables, and actual decisions with respect to the specific values assigned to the various control variables of the electrical energy control system 100. It should be noted that the use of standard networking protocols such as Ethernet and TCP/IP allow the location of the control processor to be geographically separated from the domain. The use of modular software architecture also allows the execution of multiple instances of energy control system each corresponding to a specific domain within a single large computing environment. This design approach facilitates an optional outsourcing of energy control to a provider responsible for offering this service to multiple domains.

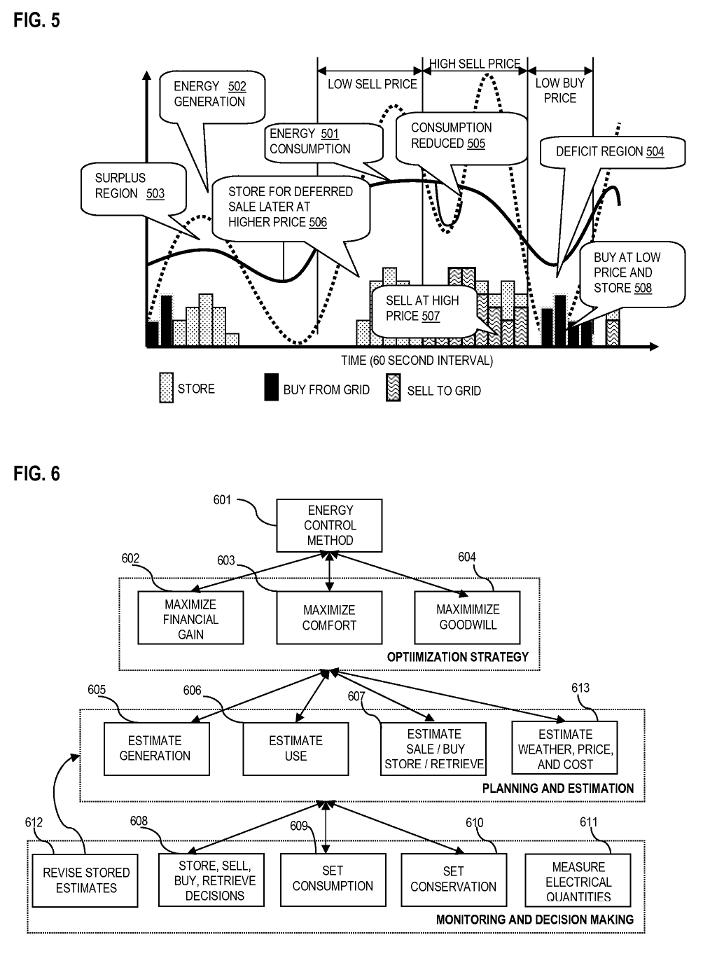

Some commonly encountered scenarios, helped by FIG. 5, are considered first to better understand the operation of the energy control system 100 and the details of the control method by showing a timeline for the various variables corresponding to energy consumed and generated for the 60 second time intervals. The solar panels 102 are actively generating electricity 502 only during the day time. When more energy is generated than used by the domain, this creates a surplus region 503. The solar panels are inactive in the night leading to a deficit region 504. During the night time, the battery 107 provides DC current to the inverter 106 which converts electricity into 120 VAC to energize the lights and limited air-conditioning (cooler nights). Again, because of appropriate decision making by the control processor 101, the battery 107 would have sufficient charge to sustain the lighting and air-conditioning loads which makes up the energy consumption 501 throughout the night when the solar panels 102 cannot operate and no energy is taken from the utility grid 112 either. The next day, the control processor 101 reconnects the solar panels 102 to the battery 107 and the electrical load and charging of battery resumes. Even though there is a surplus of energy, during a low sell price a decision is made to defer sale to later at a higher price 506. When the selling price is high, consumption is reduced 505 to maximize profits. The stored energy is sold later at a higher price 507 and when the buying cost is low, a decision is made to store energy 508 to sell or consume later.

If the capacities of the solar panel 102 and battery 107 are carefully specified to handle the average and peak loads, the solar power alone (either stored or currently generated) will suffice the electrical energy needs of the domain. In a larger configuration with higher initial capital investment, batteries 107 and solar panels 102 can have capacities that exceed the typical needs of the residence. This surplus energy creates an opportunity to sell the extra energy back to the utility grid 112. With the present invention, the control processor 1 01 decides the right time for energy sale when the selling price is high and for buying energy from the grid, if needed, when the cost is low. The battery 107 is used to store surplus energy while the control processor 101 waits for the right time for selling energy at higher price. The control processor 101 has to ensure that there is enough energy stored during the day so that the battery 107 can be used during the night when no solar energy is available while some stored surplus is already marked for selling it back to the grid 112.

In another scenario, the control processor 101 uses information from the weather web sites on the Internet 11 3 that the next day will be a cloudy and rainy one and it adjusts its decision making by reducing power sale and storing an extra charge in the battery 107 to sustain the domain load during the night and also to compensate for a reduced energy output from the solar panel 102 during the next day with reduced solar energy generation because of a cloudy weather. In yet another scenario, the control processor 101 can use the user-specified information about the expected use of the residence for a special event in the night and applies this extra information to adjust its decision making. Accordingly, it reduces the sale of extra energy and stores the surplus energy in the battery 107 to feed the extra load during the specific night time.

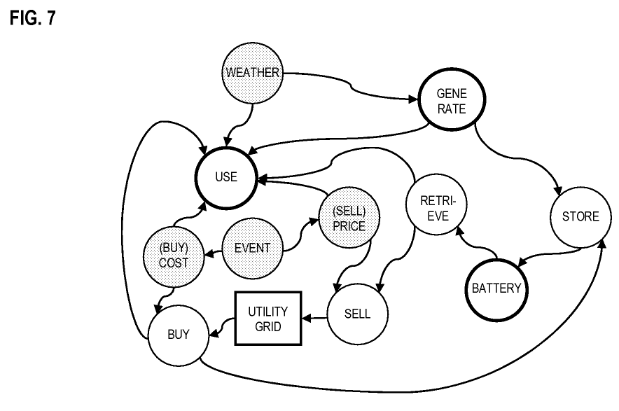

All of the above scenarios, and many others that can similarly be identified, are well supported by the energy control method 601 by applying a specific optimization strategy to maximize financial gain 602, maximize comfort 603, or maximize goodwill 604 as summarized in FIG. 6. There are multiple, in one embodiment three as described later, time-lines for the optimization method to operate efficiently within the bounds of computational capability of the processor 101. First is the highest level planning based on historical data, administrative policies, and long term weather, seasonal and usage information. This planning phase creates daily plans, recorded as estimates for electrical energy generation 605, use 606, and selling, buying, storing, and retrieving decisions 607, typically generated a year in advance. Estimations for the weather, price and costs 613 are also based on policy and information from external websites 113. This daily plan provides approximate decisions for each short time period nominally set for 60 second time interval (total 1440 intervals within a day and 525600 intervals within a time span of 1 regular year). The 60 second interval is a large enough time period to provide sufficient computing cycles for handling current conditions for near real time decision making (buy, sell, store, retrieve 608, set consumption 609, set conservation 610) collecting measurement electrical quantities 611, and for making short term predictions within the bounds already set by the long term plans and revising the stored estimated values 612. The near real time decision making is not burdened with analyzing and expanding the whole set of policies or interfacing with external data sources such as websites 113 since all the external factors have been taken care of in the planning phases.

During a specific time interval, the method uses current measurements and approximate bounds available from the planning phase, and sets the various control variables based on the existing plan (which may also have been revised earlier that day but were originally created up to a year in advance). These decisions are made in a near real-time basis and at the start of such an interval, all variable estimates, processed and stored during the planning phase, are obtained from disk drive 402. The actual values of the various voltage and wattage measurements in the power circuit are also used by the method. The weather, actual energy used, and actual energy generated information is used to fine-tune the control variables for the current interval and to revise the estimates 612 (that already preexist) for the 1440 time intervals within the next 24 hours. These updates for the short term estimates based on the actual values comprise the short term prediction and update phase. This update phase ensures that the approximate values determined during the long term planning phase, up to a year in advance, are updated for the next 24 hours with respect to the more current information and the actual measurements available to the control system during the current interval.

When the method is initiated for the first time, it goes through the planning phase for the whole year while also working on the near real time decision making based on default values for the current time interval. The updates are also performed once the decision making is done for the first time interval. This arrangement ensures that the control processor 101 (which implements the method) startup does not have to complete the yearly planning phase before it starts controlling the devices for the current interval. Immediate control is ensured with a marginal decrease in fidelity of optimal decisions for the current time interval and some future time intervals in the short term. With a threaded design (as described later) of the software programs 403 of the control processor 101 implementing the optimization method, all types of processing can proceed in parallel. When the planning phase is complete, more optimal estimates, instead of the default values, become available for near real time decision making for the subsequent time intervals.

Many facets of this invention, including the decision making methods and policies influencing them, can be better understood by using certain mathematical expressions that relate specific quantities of electrical energy and the system variables representing internal and external information associated with a specific time interval. FIG. 7 shows interdependence among the various system variables which are described blow. An embodiment of this invention can select the smallest time interval that is compatible with the desired fidelity of decisions and the computational costs and other constraints present in the system. For one embodiment such a time interval, as already mentioned, is 60 seconds. This time interval is large enough to keep the data storage and computation needs manageable and, at the same time, it is granular enough to preserve sufficient details and flexibility to adapt to the changing environmental conditions and actual energy use and generation dynamics. Let t represent one such time interval of 60 second duration in general. Accordingly, the following system variables, each indexed by the parameter t, are defined for the time interval t.

The following are the external variables and are generally not changed by the control method.

| | |
|---|---|
| Price of selling one unit of energy for time t | price(t) |
| Cost of buying one unit of energy for time t | cost(t) |
| Weather during time t | weather(t) |
| Geopolitical event during time t | event(t) |

The following are the control variables assigned specific values by the planning, decision making, and short term update energy control methods.

| | |
|---|---|
| Amount of energy sale to the grid for time interval t | sell(t) |
| Amount of energy purchase from grid for time interval t | buy(t) |
| Amount of energy storage for time interval t | store(t) |
| Amount of energy extraction for time interval t | retrieve(t) |

The following are the state variables representing the current state of the system and are influenced by both the external conditions and the control decisions (e.g., switching the power circuit switches on and off and setting thermostats) made by the method.

| | |
|---|---|
| Amount of energy generation for time interval t | generate(t) |
| Current battery charge at time t | battery(t) |
| Amount of energy consumption for time interval t | use(t) |

It is to be noted that the state variables depend on the external variables and the specific values assigned to the control variables according to the energy optimization method 602, 603, or 604. Depending on the use of a specific optimization criterion, one or more of the above variables become dependent or control variables for the optimal control method. For example, the variable use(t) can be directly changed by switching off a power circuit or by setting the water heater thermostat.

During the planning phase, each system variable is estimated based on the external, historical, and policy information accessible to the control method. Each such variable can thus assume one of the three possible roles: (1) estimated value for a future time interval, (2) actual value for the current time interval, and (3) historical value for a past time interval. Accordingly, each system variable can optionally be qualified to distinguish its current role in the algorithmic descriptions. The various constraints involving these variables can similarly be specified with respect to additional qualifications such as minimum and maximum limits. When more than one role of a variable is discussed at the same time, these roles may be suffixed as follows: EST (estimation), CUR (current), HIS (historical), MAX (maximum), and MIN (minimum). Often the context will be clear enough that such a qualification is not needed.

Policies play a crucial role in this invention for succinctly specifying the various constraints, desired objectives, and external conditions for the method. All such policies related to this method are specified, in one embodiment of this invention, using conditional statements of the following form: IF (condition)THEN (action). Most of these policies can be added or modified by the administrative entity 111. However, some initial policies containing default values for the various variables are provided during the installation of the system software. The condition part of a policy is a structured Boolean combination of one of more sub-conditions including one or more of the following: other (sub) conditions, variables (estimated, actual, maximum, minimum, or historical), time of the day, day of the week, day of the month, day of the year, week of the year, and month of the year. The action part involves a list of one or more assignment statements. Each such statement assigns a specific value to one system variable. If a time index value is provided for a system variable then only that specific time interval is affected for the variable. The specified value for a variable, on the right side of the assignment statement, could be a literal (such as constraint), or an expression involving one or more variables with specific time interval indexes and arithmetic and statistical functions over these variables. Arithmetic expressions are used in the time index parameter to provide expressiveness and flexibility. For example, a common use will be to have an index t denote the current interval and for the expression part to have an index value anchored at t such as t−1440 represents the previous day, t−60 represents the start of the previous hour, and t+20 represents the end of the second hour in future.

As an example, the following policy ensures that on cloudy November Sundays, the control system should support a minimum specified energy consumption level.

IF ((t.DAY IS SUNDAY) AND (t.MONTH IS NOVEMBER) AND (weather(t) IS CLOUDY))

THEN

use_{MIN}(t)=4 kwh

The overall minimum consumption level could be much lower (2 kwh) compared to a higher value specified for some specific days. Note that this simple policy rule will be active for every time interval (60 second interval) for all November Sundays when users are expected to stay home and consume more energy. It should be noted that a simple statement represents an extensive list of specific configuration statements which will be required in the absence of an expressive computer language used for specifying these policies.

It should be noted that the specific syntactical notation used here for defining policy can easily be changed to some other syntax and it can also use a suitable graphical user interface program for entering the components of a policy in a user-friendly fashion.

In the next example, the policy specifies actions that are activated for every time interval because of a general use of the time interval index t.

IF (use(t−60)>use_{MAX}*0.9 AND use(t−120)>use_{MAX}*0.9) THEN use_{EST}(t)=GreaterOf(use(t−60), use(t−120))

The above policy overrides the default calculation, coded in software programs, for estimating the energy use for a time interval. It specifies that if representative values from the last hour and last two hours are both within 10% of the maximum limit (represented by use_{MAX}) in the system, then the estimated value of use(t) is the greater of these two values. Note that this policy will be effective only for the planning process since it deals with the estimates. However, the policy will get activated for every time interval during the planning phase.

Each policy in the system can be assigned a specific priority to disambiguate between conflicting policies.

For example, consider the following policy

IF (t.Day is SUNDAY) THEN use_{EST}(t)=5 kwh WITH PRIORITY 50

And, the second policy which overlaps with the previous one

IF (t.Month is DECEMBER) THEN use_{EST}(t)=4 kwh WITH PRIORITY 40.

Since both of the above-mentioned policies will apply for every time interval of every Sunday of every December, a disambiguation is needed. The first policy, with a higher priority, will override the second policy and the action will be to estimate usage as 5 kwh instead of 4 kwh for all Sundays of December and 4 kwh for every day other than Sunday in the month of December.

The next policy example is active for all intervals and serves as an explicit constraint. It ensures that the energy use is always less than 80% of the specified maximum if the weather is cloudy, which would lead to less energy generation.

IF (weather(t) IS CLOUDY, for all t in [T_{C}, T_{C-120}]) THEN

use_{ACT}(T_{C})=Use_{MAX}(T_{C})*0.8

weather_{EST}(T_{C+1})=CLOUDY

The above policy will be activated in the execution of the near real time decision making method for every time interval if it has been cloudy for the past two hours. Note that a similar logic is also built into the software program which revises the estimates for the short term weather based on actual values from current and past intervals. These policies, added on top of the underlying software by the users, influence the functioning of the programs without any re-installation of the programs. This policy will require that the historical records for past two hours be retrieved from disk drive 402 to check whether the weatherACT values meet the condition for every interval during the last two hours. This example is a concise syntax for a similar condition with 120 sub conditions of the following form: weather(T_{C}) IS CLOUDY AND weather(T_{C-1}) IS CLOUDY AND weather(T_{C-2}) IS CLOUDY AND . . . weather(T_{C-120}) IS CLOUDY.

Without any qualification, all three roles of a variable are included in a policy. For example, for estimated, current, and historical the battery discharge should be less than the maximum charge the battery 107 can hold. So the following policy will get activated in all three phases (planning, near real time, and updates).

IF (TRUE) THEN

retrieve(t)<battery_{MAX}

It is to be noted that there are some default values such as battery_{MAX}, useMIN, etc. which apply for all time intervals. Some of these are also indexed for a time interval such as use_{MAX}(t) for a specific time interval t. The system uses external sources and stored data provided at the installation time and through user interface to populate the various default values first. The location of the domain (latitude, longitude) is used to determine the sunrise and sunset times. This processing uses numerical representation of differential equations that describe the movement and location of sun in the sky with respect to a specific point on earth surface. This information is combined with the expected weather at the location on the average at a specific time of the year based on historical weather records for the domain location. The pricing information, both for purchase and sale, is obtained from the external web site 113. If the site is not accessible then a default value, price_{MIN}, is used as an estimate for the time period. The price default is also included during software installation (so that the system can start immediately without completing the planning phase and even when the external web site cannot be accessed). All of these default values mentioned in this paragraph so far (price_{MIN}, use_{MAX}, battery_{MAX}, etc.) are explicit scalar values to drive the programs 403 when the system is started initially after the installation or a reset and these values are not indexed. These values are derived primarily from the analysis and engineering design study that takes place when the energy system 100 is designed and installed corresponding to overall capacity (as described earlier in a table for estimating energy generation and storage for a typical residence as a domain).

The energy control system software 403 is installed with a specific set of policies to describe the various patterns of sale prices and buying costs. Note that these values are all estimates and are activated only during the planning phase. The following policies, for example, specify a higher sale price for generated energy in the daytime and evening hours compared to the night time depending on the varying demand. The evening energy price, with a further increase in demand, is the same as the overall maximum price. And, finally, the default cost of purchasing energy is same as the cost of selling energy for every time interval (actual values and estimates) unless overridden by some more specific policy.

IF (t.HOUR>8 AND t.HOUR<17) THEN

price_{EST}(t)=0.20

IF (t.HOUR>17 and t.HOUR<20) THEN

price_{EST}(t)=price_{MAX}

IF (t.HOUR>20 and t.HOUR<8) THEN

price_{EST}(t)=0.10

IF (TRUE) THEN

cost(t)=price(t)

In the absence of any explicit policy the default value at any time interval is the same as the default scalar variable. For example, price(t)=price_{MIN} if there is no policy available for customized determination of price(t) values. More specific values of the price(t) will be obtained from a web site and the control method can then update the price tables stored in the persistent storage (based on simple default expansion by the control method). Generally, most policies are defined to be activated during the planning and update phases. The decision making phase involves significant near real time processing and generally most policy related information is already embedded in the estimates generated during the planning phase and stored in the disk drive.

Information presented so far for the control method is useful in understanding the actual algorithmic steps involved in order to implement the method and how it uses the related policies. The policy manager component of the method and its software implementation is responsible for the interpretation of all policies and expanded them into explicit values including those of generate(t), price(t), cost(t), use(t), etc. for the various time intervals in the time span. These values are stored in the disk drive and are available to the planning and decision making methods.

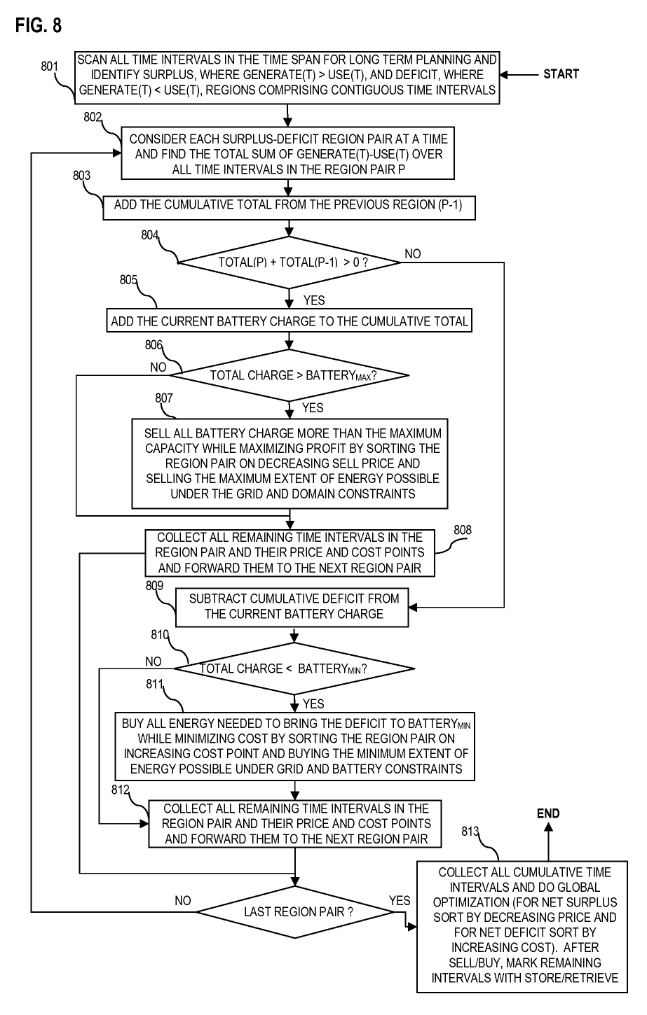

The primary functionality of the planning phase of the optimization method, for a specific time span comprising several time intervals, is described below. This textual description can be better understood by studying an associated flow chart displayed in FIG. 8 that shows the major steps and decision points in a visual form. The planning phase scans 801 the complete set of all time intervals within the time span and performs specific computations for each time interval. The scanning of all time intervals and associated computing include the categorization of the whole time span into two types of regions. A surplus region 503 includes all contiguous time intervals t such that there is more energy generated compared to what is used within the domain. Arithmetically, this corresponds to generate(t)−use(t) being greater than 0 for each such interval t. A deficit region 504 is defined as a contiguous set of time intervals t such that during each such interval there is more energy consumed within the domain compared to the energy that is locally generated for that time interval. Arithmetically, this equates to generate(t)−use (t) being less than 0 for each time interval t in the deficit set. This processing divides the whole planning time span into a series of regions alternating between the surplus and deficit types. Typically, for a residential unit using solar panels 102 for energy generation the day time will correspond to a surplus region when more energy is generated while the night time when more energy is consumed will correspond to the deficit region. It is possible that because of extreme cloudiness a typical daytime surplus region may become a sequence of three smaller regions surplus, deficit, and then surplus. As another example, in the case of an office building using wind turbines, day time would be a deficit region while nighttime would correspond to a surplus region in time, since most activity would occur during the day time while wind power will continue to be generated during the night.

The processing for surplus and deficit regions in a standalone fashion is described first to simplify the presentation. This is followed by the actual integrated method that considers surplus 503 and deficit 504 regions as a pair at a time in the long term planning phase. The planning phase for the entire time span has to make two primary decisions for each time region, depending on its type. The surplus energy can be either stored or it can be sold for a price. Similarly, the deficit energy can be bought or can be retrieved from the battery. Some less common scenarios, for example when the decision is to have energy purchased even during a surplus region and sold in the deficit region 504, are also possible and these are supported by the method. A surplus region 503 is constrained by the fact that energy cannot be stored in the battery 107 beyond a certain point because of a finite battery capacity limit. Similarly, in a deficit region 504 energy cannot be retrieved if the battery 107 is fully discharged. In situations when the battery charge is at the maximum level then it is easy to decide and sell all surplus energy for each interval while the battery stays at the maximum charge. Similarly, if the battery 107 is fully discharged then again it is easy to decide and buy the necessary energy from the grid 112.

It is more involved a decision when the battery is not fully charged and there is a surplus for a time interval t and it is to be decided whether the surplus should be sold immediately or stored for a future sale at a potentially higher price. A globally optimal solution (restricted to sale decisions for the moment) is determined as follows for such a situation. First the method finds the total surplus for the current surplus region r by adding all individual surpluses (generate(t)−use(t)) for every time interval t in the region r. The method then adds this total to the battery charge battery(t) at the start of the interval t. The method then adds any extra cumulative surplus energy (along with its prices which will be described later) from the previous region. The method then determines if the total amount of surplus energy thus accumulated exceeds the battery maximum capacity or not. If the sum is indeed bigger than the battery capacity, then the surplus, beyond battery capacity, is immediately available for a sale to the grid lest it should get wasted without such a sale. The method achieves an optimal sale within the region as follows. The method first sorts all prices, price(t), associated with each time interval t, accumulated so far, from high to low. The method then decides to sell energy for each time interval accumulated so far from the highest price point 507 in a decreasing order and stops only when the extra surplus beyond battery capacity has already been marked for sale. The method maximizes the sale at every time interval subject to how much can be sold in each of the 60 second interval to the grid, limited by (accumulated) generated amount up to that time interval and the capacity of the domain and grid circuits. For all such time intervals sell(t) is accordingly set subject to current carrying constraints of the circuit. For other time intervals, battery charge is increased by the amount used to charge the battery charge(t) for each time interval t. Depending on the value of sell(t) for a time interval, the value of charge(t) for that time interval could be less than or equal to the surplus generate(t)−use(t) for that interval. In this case, the method for the region ends with a fully charged battery.

At this stage there are two possibilities. Either the method found the cumulative surplus energy to be less than the battery capacity or the method has already marked the extra surplus for sale and the net surplus left is now within the battery capacity limit. The method has to ensure that the remaining amount of the energy surplus has to be merged with the future region(s) for a global optimization (in case the future regions may have a higher sell price and the sale would be made at that time in future 507). At the end of the current region, either the battery is fully charged or is less than its maximum charge. In either case there is a set of one or more time intervals and their prices and associated individual surplus energy values. The method collects this set of unsold intervals (both from the current region and a possible accumulation of intervals from the past regions) and forwards the set to be included in the processing for the next surplus region. The process repeats the steps described above for the next surplus region. Depending on the amount of surplus compared to the battery limit, there may be a immediate sale or forwarding of surplus to the next region. This processing continues until the method encounters the last region where it finally makes the optimal decision across all regions for all surpluses accumulated so far. The method sorts the cumulative collection on individual prices, price(t), for each interval involving intervals from potentially multiple regions. The method then starts with the highest price and makes sell decision for the maximum amount (possibly more than generate(t)−use(t) for a interval) to sell at the highest price for each time interval until the whole surplus has been exhausted. All sell decisions are recorded by setting the value of sell(t) for the affected time interval t. Note that the method checks and makes sure that sell(t) decisions ensure that battery charge for the next estimated deficit region is sufficient to meet the deficit. After the last region has been processed, the method rescans all time intervals in the forwarded set within the time span, determines the unsold amount, and decides to allocate the sum of generate(t)−use(t) gap within a time region which is not marked for sale in individual time intervals for battery charging.

The planning method accommodates the deficit region in the following way. Again, this description helps in understanding the actual integrated method which processes both surplus and deficit regions concurrently and is described later. The planning method functioning for the deficit regions is a mirror image of the surplus region processing described above. The planning method considers the use(t)−generate(t) value for each time interval within a region. The method adds all of these differences together to provide the total deficit for the current deficit region. The method then subtracts this deficit from the battery charge battery(t) at the beginning of the region. The method then subtracts any cumulative deficit from the previous region from the resultant battery charge (this is described later in this paragraph). If the resultant charge of the battery goes below 0 then the there is a net deficit of energy within the time region. The amount by which the battery charge goes below zero is the amount of energy to be purchased within this region. The method now finds the best time intervals to purchase this energy within the time region. The method sorts the individual time intervals in the region in the increasing order of buying cost. The method then uses the least buying cost and marks that time interval for energy buying such that the amount of purchase is the maximum that can be purchased (possibly more than the use(t)−generate(t) gap for a time interval by storing the extra amount in the battery, again subject to its maximum battery capacity) subject to domain circuit and utility constraint in that time interval. The net energy to be purchased in this time region is reduced by the amount that has been decided to be purchased at the lowest cost. Then the next lowest buy cost is considered for the next time interval. This processing continues for increasing buy costs until the total of all energy to be purchased equals the deficit that needed to be accommodated in this region. Once this point is achieved, then all remaining time intervals will only require that energy be retrieved from the battery for the remaining time intervals within the region. Accordingly, the retrieve(t) value is set by the method.

The deficit region method proceeds differently when the total of all individual deficits does not go below the specified battery minimum (typically 0) within a deficit region. This situation requires that these deficit time intervals need to be merged with future deficit time intervals for a global optimization of energy purchase as future buy costs may be lower than that for the current region. The method therefore collects all such cost points and the associated individual deficits and carries them forward to the next deficit region. The method then proceeds with the regular processing for the next time region. If it is the last deficit region then a global optimization of the accumulated deficits is performed. This is achieved by sorting all buy costs in increasing order first. The method then starts with the smallest cost and makes a buy decision at the lowest buy cost for a maximum possible energy for the corresponding time interval. The method then moves on to the next higher cost and continues with this processing until the accumulated deficit has been taken care of by making buy decisions equal to the total energy deficit across multiple time regions. These decisions are recorded by setting the value of buy(t) for each such interval. Once the buy decisions have been implemented, the method scans the remaining time intervals and marks them for retrieve for the amount reflected by the energy demand use(t)−generate(t) adjusted for all buy decisions already recorded as buy(t).

The above steps described for the surplus and deficit regions independently provide optimal decisions for surplus and deficit region respectively. An integrated method is actually utilized to optimally support the surplus and deficit regions simultaneously as shown in the flowchart in FIG. 8. The method considers adjacent surplus and deficit region pair at a time 802. For each such surplus and deficit pair, the method first finds out if there is net surplus or deficit in the region pair. This is achieved by adding all individual generate(t)−use(t) values and there is surplus if the value is greater than 0; less than 0 defines a deficit within the region pair. If the net value is surplus then the net surplus is added to any net surplus from the previous region pair 803. If the previous region pair was of type deficit then the deficit value is subtracted from the net value of the current region pair. The resulting value (only if it is positive) is then added to the battery charge at the start of the region pair 805 and checked if the charge will exceed the maximum battery capacity 806. If so, the extra surplus has to be sold immediately as it can not be stored for the current region pair 807. Such a sale is conducted based on the scheme 813 described later.

Similarly, if the net deficit for the current pair (as decided by 804 and adjusted by the value from the previous region 809) is subtracted from the battery charge and it reduces the charge to be less than battery minimum 810, then there has to be a buy decision made 811 to rectify substantial deficit. This buy decision is made based on the scheme 813 described later for the deficit regions. Note that it is possible that a surplus region pair becomes a deficit region pair after adjusting the value with respect to previous region pair if there was a larger deficit. Similarly, a current deficit region pair may become a surplus region pair after adjustments with respect to the previous region pair if there was a larger surplus. In either case, the method proceeds with buying or selling decisions according to the above description as shown in the flow chart. On the other hand if the adjusted surplus is less than battery capacity 806 or the adjusted deficit is greater than battery minimum 810 then the net amount is forwarded 808 to the next region pair without any immediate selling or buying decisions in order to realize a global optimization across multiple region pairs.

On reaching the last region pair, the method 813 can safely proceed with a global optimization for all such accumulated surpluses and deficits. If there is net surplus then the method sorts the by sell price in decreasing order and if there is net deficit then the method sorts by buy costs in an increasing order. The method maximizes sell or buy amounts for the corresponding time interval subject to the domain and utility circuit constraints. A sell amount could possibly be more than the generate(t)−use(t) gap (achieved by tapping into the battery while ensuring that the battery is not depleted below the minimum level allowed) for an interval. Note that a combined processing of surplus and deficit region together has already ensured that the deficit of a pair is handled first before any sell decisions are made from the surplus parts of that region pair. After the sell(t) and buy(t) values have been recorded, the method ensures that the remaining extra energy is used for charging the battery by setting charge(t) and energy to be retrieved for use by setting retrieve(t) values.

As described earlier, the method has to accommodate both selling and buying decisions simultaneously for the region pairs and is now described in more detail. During selling and buying decisions the method sorts the selling prices and buying costs of all cumulative net surpluses or deficits together such that the selling price is decreasing. The method then exercises all buying opportunities for the time intervals which have lower cost value than the price for the first sell time interval and occurring before the first sell time interval. After the first selling decision and reducing the net surplus, the method again puts all the remaining buy time intervals with cost less than the sell price of the second sell time interval and occurring before the second sell time interval. The method continues in this fashion until the net surplus has been taken care of. It should be noted that many buy decisions may have also been made at low buy costs. If the method has taken care of all sales and is still left with a current amount that is different from the target then the method needs to sort the remaining buy time intervals and buy the maximum amount possible at the lowest price. This will ensure that the method is buying low and selling high without exceeding the maximum capacity of the battery or depleting the battery below the minimum value. It is required to keep sorting, at every step of sorted sell prices, the remaining buy costs as they become the driver for that iteration. This is complex processing as the remaining set has to be resorted for each selling or buying decision. While the iterations continue, the method keeps revising the current net surplus until it reaches the total net value calculated earlier without exceeding the battery capacity or fully draining it. After the buying or selling decisions have been recorded as sell(t) and buy(t), the remaining intervals get their resultant retrieve(t) or store(t) values based on generate(t) and use(t) values and the decisions already made for the values of sell(t) and buy(t).

It is to be noted that the steps used by the planning method deal with the original estimates of the various buying and selling decisions to be used later in decision making for a specific time interval. The decision making method for a specific current time interval uses the actual value of generate(t), battery(t), and use(t) and adjusts the retrieve(t), store(t), sell(t) or buy(t) values accordingly. The update method also uses the actual values for the current period and runs a short term planning phase processing just for a 24 hour period with adjusted values of weather and actual values from the decision making method to revise the various short term estimates. The first such updates are for the values of the state variables generate(t), battery(t) and use(t) which then lead to possible changes in the control variables, including retrieve(t), store(t), sell(t) or buy(t), consistent with the planning method described above.

The above processing achieves optimization with respect to financial gain 602 of FIG. 6. By deciding to sell more than the generate(t)−use(t) gap for a time interval when the price is high and buying more than the use(t)−generate(t) gap for a time interval when the buy cost is low, the method ensures that it works as an efficient buyer by buying low and selling high. This objective is achieved independently by a judicious use of the battery energy storage capability. It is easy to implement other strategies by changing some of the steps of the method described earlier. For optimizing comfort 603 of FIG. 6, the focus will be on maximizing energy consumption or the value of use(t) for a time interval. This essentially requires that the logic for estimating use(t) in the planning and update phase need to be slightly modified. For maximizing the use of green energy (goodwill) 604 of FIG. 6 the aggregate purchase (sum of buy(t) over all time intervals) is to be minimized as opposed to maximizing the dollar amount with respect to buying and selling decisions. In order to achieve this objective, the corresponding method 813 sorts for the generate(t)−use(t) gap in decreasing order for the surplus region pair, as opposed to sorting on price points for surplus processing which is used for maximizing profit. For deficit region pair processing, sorting in 813 will be on use(t)−generate(t) gap in increasing order. Other steps and constraints such as battery and grid capacities are same as for the financial gain objective. In these cases, buying costs are not interspersed with the selling decisions and sell prices are not interspersed with buying decisions, respectively for surplus and deficit region pairs. If energy needs to be purchased because of a significant deficit, such purchase would happen eventually as the later part of the method. This adjusted method ensures that minimum energy is taken from the grid, as opposed to the case when the domain makes most profit which may lead to buying from the grid at low cost and selling back at a higher price. The method ensures that there will be a sale of energy only if there is extra energy but not because of profiteering achieved by buying low and selling high. It should be clear to the workers skilled in these arts that other optimization strategies are easily possible by permuting these options, adding some variations, and combining them in many different combinations.

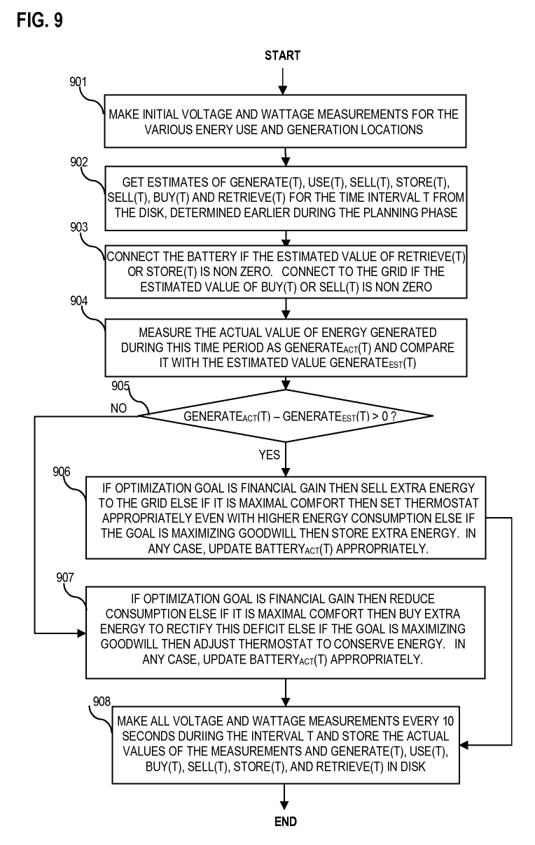

The near real time decision making method, shown as a flow chart in FIG. 9, starts with making all voltage and wattage, for example 210 and 21 1, measurements at the various generation and use points 901. It then uses the estimates represented by the following variables generate(t), use(t), sell(t), store(t), sell(t), buy(t) and retrieve(t) for the current time interval t 902. These values were initially determined by the planning method and potentially revised by the update method which was run for time intervals preceding the current time interval the near real time decision making method is running for. If there is no energy generation (for example during the night time) and the estimated value for retrieve(t) is non zero, then the batteries 107 are connected over the configurable power circuit by directing the corresponding switch 202 (or no change if they are already connected) to the inverter and the load 903. The method also uses the wattage 211 at the battery input at the start and end of the interval to determine the total use of battery during the interval. During the day time, there could be generation of energy within the domain. The method checks the value of actual generation generate_{ACT}(t) by considering the solar panel wattage (using 211 and 212 readings) at the start of the time interval t 904. If generateACT(t) is greater than generate_{EST}(t) 905 for the current time interval then the difference is handled in the following fashion. If the overall optimization goal is to maximize financial gain and the policy guidance is not to store energy, then the extra energy is sold to the grid 906. If the overall optimization strategy is to maximize comfort then the thermostat setting for the air-conditioning device and water heater device (for example) is adjusted proportional to the expected difference. If the earlier determined plan is to store energy then the battery is connected to the solar panel output and the extra energy is used to charge the battery for the interval. On the other hand, if the actual energy generation is expected to be lower than the estimated value and the objective is to maximize comfort then a retrieve or buy decision is made 907. Otherwise, the control processor decides to set the thermostat lower for heating so that this unexpected energy deficit can be taken care of without any purchase from the grid or retrieval from battery. At the end of the time interval the actual values of the various system variables (actual values) and measurements are stored in the disk for future use 908.

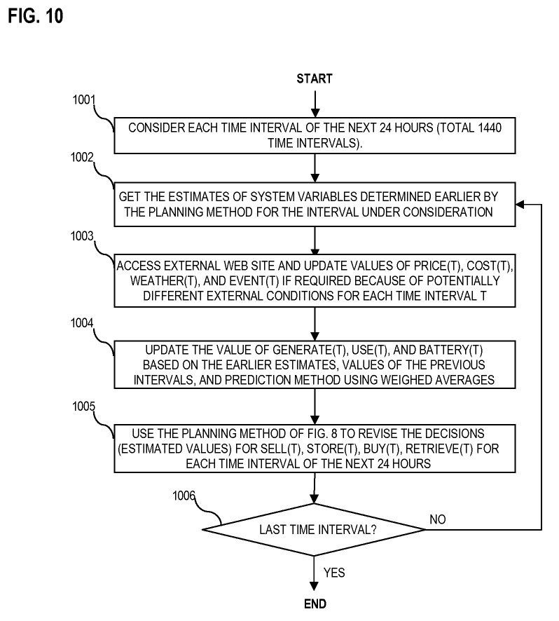

The update method, shown in FIG. 10 as a flow chart, is similar to the planning program with a difference that the starting point is the set of actual values at time t and that the update method only covers all the time intervals for the next 24 hours 1001 (1440 time intervals in total). It gets the estimates of the system variables determined earlier by the long term planning method and already stored in the persistent memory for later use 1002. The update method also accesses the web site for pricing and weather updates for the next 24 hours and can revise price(t), cost(t), weather(t), and event(t) values 1003. For each time interval in the short term, the update method uses the existing estimates and applies a prediction method to update the values. The variables needing such updates include generate(t), use(t), and battery(t) 1004. A weighted average with exponentially decreasing weights for time intervals farther in the past from the current time interval is used for averaging. The estimates for energy generation are updated based on the actual values from the immediate past provided they are from the close periods for the same day and similar periods from every day in the past week. The estimates for consumption also have time of the day variation so immediate actual values for such similar time periods are included for the day and also from past the 7 days. Once the estimates for the system and external variables have been revised based on actual conditions and external sources, the update method executes a planning process, as described in FIG. 8, but only for the next 24 hours 1005. Accordingly, it updates the values for control variables sell(t), buy(t), retrieve(t), and store(t). If this is the last time interval 1006, then the method ends, else the estimates for the next time interval are obtained from the disk and processing continues as described above 1002.

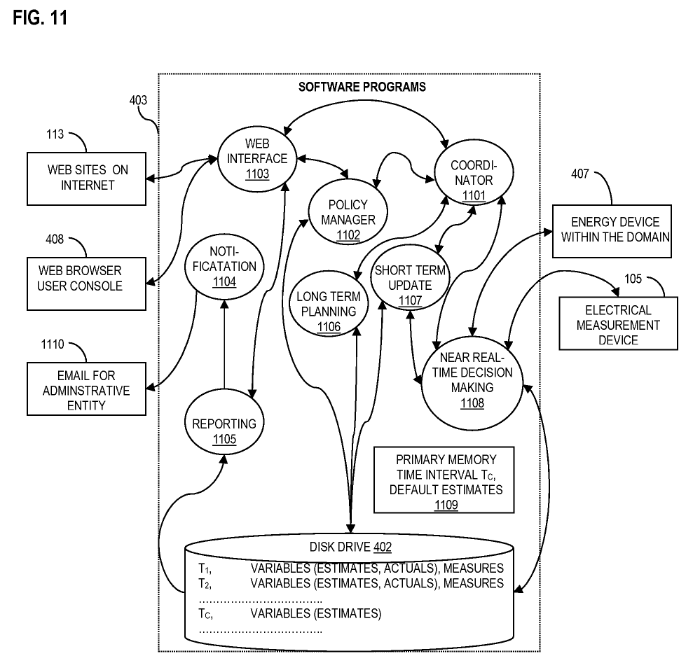

The software program 403 product of this invention, in one embodiment as shown in FIG. 11, is implemented as a collection of multiple software processes, each handing a specific aspect of the energy control method 601 and interfacing with the entities within the domain and outside the domain. A software program 403 is implemented as a computer process with a multi-threaded design so that only a thread is potentially blocked while awaiting some external or internal event while other threads in that program can proceed with their respective computational task. In subsequent discussions software process and program are interchangeably used. It should be noted that all of these software programs are running under the control of the operating system (OS) on a CPU. The operating system boots when the control processor 101 is switched on or after a reset of the control system 100. As a part of the automatically scheduled programs, the energy control software main program, called coordinator 1101, is started by the OS. The OS scheduler also looks at an OS table for all other regularly scheduled software programs specified for timed execution (for example the cron table of the Linux operating system). The main coordinator program 1101 starts the policy manager program 1102 which accesses the disk drive 402 and fetches all policies for the operation of the control system. Then the coordinator program 1101 fills in the default values for the various estimates which are also present in the persistent storage for generate(t), use(t), sell(t), store(t), price(t), buy(t), and retrieve(t) and populates the primary RAM memory with the default values 1109. Even when the energy control programs are run for the first time, these default values are always present in the disk as part of the software installation based on the capacity of devices at installation time (battery, solar photo-voltaic, average load, etc.). The availability of the default values in primary memory allows the near real-time decision making program 1108 to start immediately, without waiting for the planning program 1106 to finish first. After the default values are available, the coordinator program 1101 also starts the decision making program 1108. The coordinator program 1101 starts the planning program 1106 but the program works on a time interval only after all policies have been read and interpreted for that time interval. Thus the planning program 1106 can shadow the policy manager 1102 for every time interval included in the one year time span. The decision making program 1108 can start functioning immediately using the default values for the various estimates 1109 (if the planning program has not updated the estimates for the current time interval based on the external information).

Other than the initial startup of the control programs 403 after installation or a reset, the planning program 1106, in general, runs for the new time interval t_{new}, which is a year ahead in future compared to the current time interval. The value of a system variable at index t_{new} depends the stored estimates for that variable at the time intervals immediately preceding t_{new}. The various system variables are stored in the persistent storage 402 indexed with the time interval. So the value t_{new-1} and other specific intervals before that, are used for the time interval index t and the corresponding external and state variables generate(t), use(t), price(t), cost(t), weather(t), event(t) and battery(t) are read from persistent storage 402 where time index t=t_{new}−1. The long term planning program 1106 uses the specific prediction methods, external information, and policy to determine the estimated values for the new time interval t_{new}. Note that the planning method 607 will determine the estimates for the control variables sell(t), buy(t), retrieve(t), and store(t) as described in the flow chart of FIG. 8.

Suitable system engineering prediction techniques are used for estimating electrical energy consumption, generation, and the purchase and sale prices used in the various programs 1106,1107, and 1108. The consumption estimation subprogram, implementing the method 606, to estimate the energy consumption value based on respective values from a year ago (day and time of the day), a month ago (day and time of the day), a week ago (day and time of the day), and a day ago (time of the day). Specific weights are used for these multiple constituent values and a weighted average is used as the estimated value of the energy consumption variable use(t) for the new time interval. Similarly, a weighted average of multiple historical values (year, month, week, and day) are used to estimate the value of energy generation variable generate(t) for the method 605. The estimated buy and sell prices are more influenced by the energy futures (available from respective web sites) which are then combined with historical values (year, month, week, and day), as determined by method 613. Weather estimates are performed by combining the current weather with the weather that existed a year ago. An “average” is used to estimate the weather for a year from today. Note that unlike energy consumption, generation, and pricing which can have yearly, monthly, weekly, and daily repetitive patterns, weather from one year from today is likely to depend more on the day of year which accommodates seasons and daily variations in a season. Additionally, weather is also likely to depend on the actual weather as recorded in the past few days. The estimated values for the time interval t_{new} are then stored back in the disk drive with the timestamp index t_{new}. The planning program can now determine the estimated values of the control variables sell(t), buy(t), store(t), and retrieve(t) as already described earlier for the corresponding planning method with flow chart in FIG. 8.

To minimize repetitive calculations, the short term revision of the estimates performed by the update program 1107, based on the update method 612 illustrated in flow chart in FIG. 10 can be executed only once per day, typically during the first time interval of the very first hour of a day right after mid night. If the short term revision is done on a more frequent basis, more accurate measurements could be made, but more processing time would be needed to handle the constant renewal of variables every 60 seconds. If the external web sites are not accessible at the time of the revision then this update is re-attempted multiple times (and notification to the administrative entity 111 is generated if there is an error after a fixed number of such reattempts).

The decision making program 1108 fetches from the disk the estimates for the following variables, namely, generate(t), use(t), sell(t), store(t), sell(t), buy(t) and retrieve(t) for the current time interval t. These values were initially populated by the planning program 1106 and potentially revised by the short term update program 1107 which was run for time intervals preceding the current time interval the decision making program is running for. If there is no energy generation (for example during night time) and the estimated value for retrieve(t) is non zero, then the batteries are connected over the configurable power circuit 110 (or no change if they are already connected) to the inverter 106 and the load. The program also determines the wattage at the battery in put at the start and end of the interval to determine the total use of battery during the interval. During the day time, there could be generation of energy within the domain. The program checks the value of actual generation generate_{ACT}(t) by considering the readings from the inverter wattmeter 212 and battery wattmeter 211 at the start of the time interval t. If generate_{ACT}(t) is greater than generate_{EST}(t) for the current time interval then the difference is handled in the following fashion. If the overall optimization goal is to maximize financial gain and then the policy guidance is not to store energy, then the extra energy is sold to the grid. If the overall optimization strategy is to maximize comfort then the thermostat setting for the air-conditioning device and the water heater device (for example) is adjusted proportional to the expected difference. If the overall guidance is to store energy then the battery is connected to the solar panel output and the extra energy is used to charge the battery for the interval. Note that these decisions are made in the beginning of the interval and are not changed while the interval lasts. On the other hand, if the actual energy generation is expected to be lower than the estimated value and the objective is to maximize comfort then a retrieve decision is made. Otherwise, the control processor decides to set the thermostat lower for heating so that this unexpected energy deficit can be taken care of without any purchase or retrieval from battery. The following measurements are made multiple times during the time interval: battery 211, inverter 212, and utility grid 210 voltage and wattage. There are 6 such readings within a time interval and the average for each set of multiple values (between the start and the end) is determined and the value is stored in historical table with a time stamp corresponding to the time interval. Any energy conservation decision for devices with a local controller (e.g., thermostat) also has a timer that is set by the control software whenever the objective temperature value is changed. The value is not changed until the timer has expired. This ensures that the directives from the control processor are not too frequent as that could lead to thrashing in the device under control.

Right after the decision making program 1108 of FIG. 11 has completed various measurements and determined the averages of the measured values, the update program 1107 can start functioning. The functioning of the update program is similar to the planning program 1106 with a difference that the starting conditioning is the actual values at time t and that the update program only covers all the time intervals for the next 24 hours (1440 time intervals). For each time interval in the short term, the update program retrieves the existing estimates from the disk drive, uses the prediction method to update the values, and then stores the updated estimates back in the persistent storage table. This includes generate(t), use(t), price(t), battery(t) and cost(t) for a time interval t. The update program also accesses the web site for pricing and weather updates for the next 24 hours. This information is used to update the original estimates determined by the long term planning program 1106. To avoid multiple web accesses 1440 times a day, it is possible to get all 1440 values at once during the first hour of the day for the entire duration covering 24 hours. The assumption is that the weather forecasts and pricing information would not change much within a 24 hour period. Weather and price updates every 60 seconds will provide more up-to-date information at the cost of large number of external web accesses and computer processing which can be avoided in most cases which do not have rapidly changing weather. However, a live Internet feed with current weather information and forecasts will help make better decisions. The weather estimates for the next 24 hours are revised based on weather forecasts and the actual weather for the past day and week. A weighted average with exponentially decreasing weight for time intervals farther in the past from the current time interval is used for averaging. This reflects basic continuity in weather (if it is raining right now, there is a good chance that it will continue raining the next minute as well). The estimates for energy generation are updated based on the actual values from the immediate past provided they are from the right period for the same day and similar periods from every day in the past week (there is no purpose in including nightly non generation periods for this average). The estimates for energy consumption also have time of the day variation so immediate actual values for such similar period are included for the day and also from past the 7 days. The updated estimates will be used by the decision making program 1108 for the future intervals (in the next 24 hours) reflecting the actual weather and energy conditions. Once the estimates for the system and external variables have been revised based on actual conditions, the update program 1107 performs the various planning program 1106 steps as described earlier, but only for 24 hours, and updates the values for control variables sell(t), buy(t), retrieve(t), and store(t).

The core functioning of the control system 100 is implemented with planning 1106, update 1107, and decision making 1108 programs as shown in FIG. 11. There are some additional programs including web interface, policy manager, notification, and reporting program, needed so that external entities can interact with the control system.

The first function of the web interface program 1103 is to respond to an external web browser over the HTTP protocol as an administrative entity accesses the energy control programs 403. A web page is provided by the control system which asks for the user login name and password. This information is checked with the stored values and once authenticated a menu is provided to the user to access the following information from the system: policy manager, historical report, current conditions, estimates for future interval, and recommendations for the daily use of high power devices.

The policy manager program 1102 is responsible for managing all policies that drive the execution of the various control programs 403. A detailed menu is provided so that the administrative entity 111 can enter, read, or edit policies. This includes a display of a hierarchy to categorize different types of policies. Under each hierarchy level, the actual policies created so far are listed. Each policy can be clicked which opens an editor allowing the user to review and change the policy. Once the changes are submitted to the energy control system 100 the policy manager checks for syntactic correctness of the policy. Then the policy manager program compares the policy with other policies to detect any other conflicts. Such inter-policy conflicts are flagged to the user for making modifications. The user can also delete an existing policy through this interface. The policy manager is also responsible for interpreting each policy and expanding and translating them for providing default values and changing the behavior of various programs as described earlier.

There are multiple data structures used in the Random Access Memory (RAM) 1109 to support the operations of the various programs. These programs can use arrays, linked lists, trees, graphs, indexing, and hash structures for a fast access of the specific components of data structures for reading and writing various values. Any shared access is protected with the use of mutual exclusion primitives so that data changes can correctly be made without allowing any nondeterministic overlapping changes by two program writers working simultaneously. The historical information used by these programs is stored in disk drives using, in one embodiment, database management system (DBMS) tables. The tables are indexed with values used for indexing which includes timestamps. Policies are also stored in a separate policy table and each policy is indexed by policy id, time interval when the policy will be active and individual variables that are included either in the condition or the action part of the policy. This indexing allows the various programs to quickly access all policies which are relevant for a time interval or which involve a specific variable.

The reporting program 1105 is invoked by the web program 1103 if the user selects the report option. It asks the user for the time duration for which a report is to be generated. Then the reporting program asks the user for the specific variables that are to be included in the report. Then the reporting program asks for the sorting order where the user can include one or more parameters. The user input is used to select a subset of information which is directly available in the persistent tables or can be derived from the stored information. The requested information is retrieved, sorted, and processed (to generate statistical measures such as mean, deviation, max, min, etc.). After all calculations are performed the output values are marked up using either extended Markup Language (XML) or Hyper Text Markup Language (HTML) and the resultant information is provided to the web browser over HTTP. The selected values could be the actual values for a historical interval or estimated values for any interval in the past or the future. All state, external, and control variables and measurements such as voltage and wattage can be selected by a user for reporting.

The recommendation information is generated using the reporting program 1105 that goes through the persistent information (estimates) for the near future (24 hours) and uses these estimates for energy generation and buying decisions and corresponding time intervals and determines for each interval if energy is being sold or not. If there is a net sale then it determines the time interval when the price is lowest and also gives it the highest ranking. Then it finds the next time interval for the remaining prices. All such time intervals are sorted in a list of increasing sell price. Then the program collects all these time intervals where energy could be sold and thus prepares a table of time intervals where this surplus power can instead be used for heavy duty consumption devices. It then looks for buying estimates, and a similar table is created where the time interval during which the power purchase is least costly is selected at the top. The total energy which is planned to be purchased is added up and recommendation made that the time interval at the top be used first since it has the lowest purchasing price. These two tables are shown together with the least price sale interval at the very top. For a weekly recommendation, similar reasoning is made but at the aggregate level of weekly energy sale or purchase. Thus the user can get a list of next 7 days and for each day the recommendation includes a sorted list such that the least sale price is at the very top and highest buying price is at the bottom to maximize financial gains. It should be noted that independent of the optimization strategy (comfort, goodwill, or financial gain), the recommendations are driven by already determined and recorded buying and selling decisions. Since any optimization strategy ultimately results in buying and selling decisions which reflect the selected optimization criteria.

The notification program 1104 keeps track of the preferred email identifiers of the users and the type of information they want to be sent automatically. This information includes various reports and recommendations the users have specified to the system. The notification registry associates a name with a specific date and time when that named item has to be sent using the specified email identifier. The date and time can also be specified in a recurring fashion (as every day or every week or every month) for the notification. Email is sent from the control software by using the Simple Mail Transfer Protocol (SMTP) and retrieved by a user using Internet Message Access Protocol (IMAP) or Post Office Protocol (POP) over TCP/IP. The user mail access program connects to a specified IMAP or POP server, provides a login name and password and then transfers the specified information packaged by the reporting program 1105 (retrieved from the disk drive tables) and sent as the email body over SMTP. Besides textual data, HTML or XML markup is used for providing necessary structure and formatting to the information. The body of such an email message can also include Uniform Resource Locater (URL) pointing back to the web server supported by the control program so that the users can access more detailed information by a single click from the email they are reading in an email agent. Additionally, the notification program can use HTTP to interact with an external web site and send information programmatically to the external systems. These options allow the users to have a convenient access to all information collected and processed by the energy control system 100. This information helps the user understand the functioning of the system, draw long term conclusions, make further capital investment decisions, and optionally use this information in some other system to make further decisions and optimizations outside the scope of the automated domain based energy control system.

It should be possible to anticipate many modifications and adaptations based on the general conceptual descriptions and fundamental principles envisioned under this invention. All such variations should be considered as specific instances of the various claims enumerated above and should be within the scope of the invention.

What is claimed is:

1. An automated electrical energy control system for a domain comprising: (a) software-based control processor for monitoring and control of (b) energy generation (c) energy storage (d) energy consumption (e) energy conditioning such as DC to AC conversion with inverters, and (f) energy conservation facilitated by the use of (g) electrical energy measurement and control, (h) configurable electrical power circuit, (i) local area network for data transmission and supported by the following: (j) human computer interface for providing policies for energy control, (k) electrical connection to external power grid, and (l) Internet connectivity to external information sources such that the control processor provides near real-time directives affecting energy generation, consumption, conservation, storage, buying, and selling where the execution of the control process is driven by the policies established by the administrative entity responsible for the domain

2. The energy control system according to claim 1 wherein energy generation in the domain is achieved with the use one or more of the electrical energy generation devices including:
solar photo-voltaic panels that convert solar energy into electrical energy and which are connected to the domain power circuit with switches and required energy conditioning; and
wind turbines that convert wind kinetic energy into electrical energy and which are connected to the domain power circuit with switches and required energy conditioning.

3. The energy control system according to claim 1 wherein energy measurement uses one or more electrical and electronic devices that can measure current electrical quantities associated with a specific location of the domain power circuit including voltage, current, frequency, and power (rate of energy) and where these measurement devices are data linked to the control processor over the local area network or Internet.

4. The energy control system according to claim 1 wherein energy consumption in the domain is achieved by one or more energy consuming devices typically used in residential or commercial facilities for lighting, air-conditioning, work equipment, heating, and other purposes where some of these devices are equipped with switches, directed by the control processor over the local area network or Internet, that can switch them on and off or set a device at a specific operational level on a continuous scale.

5. The energy control system according to claim 1 wherein energy storage in the domain is achieved with one or more devices that can convert electrical energy into one or more of the following forms including:
chemical (such as a battery), kinetic (such as a flywheel);
thermal (such as steam or ice maker);
and potential (such as pumping water to a higher level) energy and which are connected to the domain power circuit and which are also data linked to the control processor.

6. The energy control system according to claim 1 wherein there is a configurable electrical power circuit comprising electrical wires, circuit breakers, distribution panels and mechanical, inductive or electronic switches that connect or disconnect, under control processor directives, the various energy generation, storage, consumption, and conservation devices for the actual flow of electrical energy within the domain and for a connection to the utility grid for buying and selling electrical energy, compatible with the energy control decisions.

7. The energy control system according to claim 1 wherein the system comprises:
a local area network comprising a selective combination of WiFi, Ethernet-over-Power Line, wired Ethernet, and Serial Line, that provides network connectivity between the control processor and the various energy generation, storage, consumption, conditioning, measurement and conservation devices exchanging electrical energy over the domain power circuit; and
a network interface connecting the network control processor to the Internet so that it can access a variety of information sources such as weather forecasting and pricing data for improving the optimality of decision making, to provide sustainable energy generation reporting data to specific Internet sites, and to provide access to the various domain energy devices.

8. The energy control system according to claim 1 wherein there is an electrical interface supported by the configurable power circuit between the domain electrical power circuits and the public utility power grid that could be used to buy energy and to sell energy under the control of the control processor.

9. An energy control method for optimal monitoring and control of electrical energy (a) generation (b) storage (c) consumption (d) conditioning, and (e) conservation, based on (f) electrical energy measurement, (g) policies provided by administrative entity, (h) information from external sources for weather, geopolitical events and pricing, and (i) estimates for energy generation, consumption and pricing data performed using various system engineering techniques.

10. The energy control method according to claim wherein monitoring and control supports:
a method that maximizes the overall financial gains with respect to purchase of energy when the price is low and sale of energy when the price is high by storing excess energy, generated or purchased, awaiting sale at a future time and by controlling energy consumption based on policies; and
a method that maximizes goodwill with respect to the maximization of generation of energy using sustainable sources such as wind and solar and using storage device to store excess energy to be used at a future time when the demand exceeds the generation at that time and by controlling energy consumption; and
a method that maximizes comfort of the users with respect to the use of electrical energy in a variety of consumption devices based on the information from the users, policies from administrative entity and within the constraints of energy available from generation, purchase, and storage.

11. The energy control method according to claim to wherein electrical energy estimation comprises:
a method that uses information about external weather forecasts, processes monitoring data from energy consumption devices, processes locally stored historical data about energy consumption in the domain, processes information from the Internet about geopolitical situations, processes stored information about user preference and usage estimates, and determines the expected energy consumption for a specific period of time in future; and
a method that uses information about external weather forecasts, processes current monitoring data from energy generation devices, processes power generating characteristics from models of the devices, processes stored historical data about energy generation in the domain and determines the expected energy generation for a specific period of time in future; and
a method that uses information about external weather and climate forecasts, published energy prices from power utility organizations, power trading organizations, power brokerage organizations, and reports from governmental and nongovernmental groups about future pricing trends, processes historical data about selling and buying prices for the domain, and determines the expected energy buying and selling prices for a specific period of time in future.

12. The energy control method according to claim wherein a near real-time method makes decisions to control energy consumption, energy storage, energy retrieval, and buying and selling for the current time interval based on the estimated generation, estimated consumption, and estimated selling and buying decisions already determined and available to the control processor as stored data.

13. The energy control method according to claim wherein an estimate revision method updates the earlier determined energy consumption, retrieval, storage, buying, and selling estimates for the near future time intervals based on the actual measurement values from the current time interval and any new information for the near future weather forecasts, near future selling and buying prices, near future energy use information, and near future geopolitical changes.

14. An energy control processor wherein one or more software programs are implemented on a computer comprising central processor unit, main memory, and persistent storage for data and programs and network interfaces for monitoring and control of domain electrical energy devices, for obtaining policies set by the administrative entity and for gathering weather, pricing, and geopolitical information available from the sources outside the domain, and providing sustainable energy measurement data to specific sites on the Internet.

15. The energy control processor according to claim, wherein there is a software program that interfaces with an external web browser user interface that allows the administrative entity to provide, review, edit, browse, and store policies and that implement specific selected facets of the control method in monitoring and controlling of the various energy devices for optimal consumption, retrieval, storage, buying, and selling of energy.

16. The energy control processor according to claim, wherein there is a software program that converts and translates electrical characteristics including voltage, current, power, and frequency provided by measurement device at a specific location in the domain power circuit obtained over the domain local area network or Internet into data items that can be used by the optimization software programs.

17. The energy control processor according to claim, wherein there is a software program implementing:
the ability to control energy consumption and conservation devices by sending data items over the domain local area network or wide area network to respective devices and thus by setting their energy consumption level which, in the extreme, can range from dual states of device being on and off; and
the ability to switch on or switch off specific switches in the domain power circuit that interconnect the various power generation, storage, consumption, and conservation devices by sending data items over the domain local area network or Internet to the specific locations in the domain power circuit where individual mechanical and electronic switches are turned on or off resulting in the proper connectivity among the devices for the desired level of power retrieval, consumption, storage, conservation, selling, or buying.

18. The energy control processor according to claim, wherein there is a software program implementing an energy optimization method providing:
the ability to maximize overall financial gains with respect to purchase of energy when the price is low and sale of energy when the price is high by storing excess generated or purchased energy awaiting sale at a future time and controlling energy consumption based on policies; or
the ability to maximize goodwill with respect to the maximization of generation of energy using sustainable sources such as wind and solar and using storage device to store excess energy to be used at a future time when the demand exceeds compared to generation during that time in future, and by controlling energy consumption; or
the ability to maximize comfort with respect to the use of electrical energy in a variety of consumption devices based on the preference information from the users and governed by the policies from administrative entity.

19. The energy control processor according to claim wherein there are software programs that implement:
a consumption estimation method;
an energy generation estimation method;
a selling price and buying cost estimation method; and
which use information about external weather forecasts, processes monitoring data from energy consumption devices, process locally stored historical data about energy consumption in the domain, process information about geopolitical situations and pricing trends, process information about user preference and usage estimates, and determine expected energy consumption for a specific period of time in future.

20. The energy control processor according to claim wherein there is a software program that implements a near real time method that makes decisions to control energy consumption, energy retrieval, energy storage, and buying and selling for the current time interval based on the estimated generation, estimated consumption, and estimated selling and buying decisions already determined in advance and available to the control processor.

21. The energy control processor according to claim wherein there is a software program that implements an estimate revision method that updates the earlier calculated energy consumption, generation, storage, retrieval, buying price, and selling price estimates for the near future time intervals based on the actual measurement values from the current time interval and any new information for the near future weather forecasts, near future energy use information, near future selling and buying prices, and near future geopolitical changes.

22. The energy control processor according to claim wherein there is software program that has an interface with external data sources providing information about the users of the domain, their calendar, their preferences and priority for energy consumption, and their estimates for the devices usage in future.

23. The energy control processor according to claim 14 wherein one or more software programs are governed by a computer policy language specified by the administrative entity for the energy control system to define estimates, patterns, internal and external constraints related to generation, consumption, storage, retrieval, buying, weather, selling, selling price, and buying cost of electrical energy within a domain.

24. The energy control system according to claim 14 wherein there a control processor with optional functionality:
that measures electrical energy generated using sustainable sources such as solar and wind over a specific time interval, stores the measurements for local use, and provides this information over the Internet to specific web sites that track such generation at various jurisdiction levels such as within multi-national alliance, a continent, a country, a subunit of a country, and sub-subunit of a country such that the aggregation of such measurements can be used in the various energy bartering scenarios such as those for changing fossil fuel usage against quotas set according to various treaties among these jurisdictions;
that collects electrical energy consumption information from the various devices, compares them with the expected consumption under similar environmental conditions and simulated data generated from models of these devices, and provides statements about the performance and fault characteristics of these devices for preventive maintenance using email and or web browser; and
that provides with a web interface that analyzes the stored actual electrical energy generation, consumption, estimated plans, constraints, pricing information, and historical information and makes recommendations about the preferred time for using high energy consumption devices for short term future which is compatible with the current optimization criteria and user preferences.
